(19) United States
(12) Patent Application Publication
(10) Pub. No.: US 2006/0033016 A1
(43) Pub. Date: Feb. 16, 2006

(54) Touch panel

(75) Inventors: Takashi Ogawa, Anpachi-gun (JP); Shoichiro Matsumoto, Ogaki-city (JP)

Correspondence Address: MORRISON & FOERSTER LLP, 1650 TYSONS BOULEVARD, SUITE 300, MCLEAN, VA, 22102, US

(73) Assignee: SANYO ELECTRIC CO., LTD., Osaka (JP)

(21) Appl. No.: 11/196,499

(22) Filed: Aug. 4, 2005

(30) Foreign Application Priority Data
Aug. 13, 2004 (JP) 2004-235835
Aug. 5, 2004 (JP) 2004-229576
Jul. 13, 2005 (JP) 2005-204115

(51) Int. Cl. G06M 7/00

(52) U.S. Cl. 250/221

(57) ABSTRACT

A photosensor and a display unit are fabricated on the same substrate. Input coordinates are identified by comparing the light quantities at positions (pixels) which is and is not touched by a finger or the like by use of a comparison circuit. Thus, TFTs to form the photosensor can be fabricated on the same substrate in the same process, and also reductions in manufacturing cost and the number of parts can be realized. A region required for disposing a sensor in the circumference becomes unnecessary, thus realizing the miniaturization of the device. Moreover, since a region to be a blind spot is eliminated in the display unit, it is possible to utilize the display unit effectively. It is possible to improve the precision of an input recognition and to uniformly perform detection all over the display unit. Furthermore, since the photosensor is constituted of a photoreceptor circuit which is capable of adjusting the sensitivity of receiving light, it is possible to make the sensitivity of receiving light (detection) uniform in the display unit.

### BACKGROUND OF THE INVENTION

1. Field of the Invention

The present invention relates to a touch panel, and particularly relates to a touch panel in which a photosensor is incorporated on the same substrate as a display unit.

2. Background Art

Among current display devices, a flat panel display is widespread due to market demands of reduction in size, weight and thickness. A photosensor is incorporated in many of display devices of this kind, such as, for example, an optical touch panel in which input coordinates are detected by blocking light and a device in which external light is detected to thereby control the brightness of a display screen.

FIGS. 20A to 20C show optical touch panels as an example. An optical touch panel 300 shown in FIG. 20A has on a substrate 301: a display area 302 in which many display elements 315 are disposed; and light emitting devices 303 for emitting light such as infrared rays and photoreceptive devices 304 for receiving light, both devices being disposed in the perimeters of the display area 302. The light emitting devices 303 are provided along two sides of the display area in the row and column directions. The photoreceptive devices 304 are provided on the other two sides, individually corresponding to the light emitting devices 303. By providing a reflector 305 on the circumference of the substrate 301, the light of the light emitting devices 303 is reflected, thus causing the photoreceptive devices 304 to receive the light. In other words, light such as infrared rays in a matrix form covers over the display area 302. The optical touch panel 301 of this kind is for detecting, as the input coordinates, a point (a blackened circle), where infrared light does not reach to the photoreceptive devices 304 by blocking the infrared light by use of a finger which is attempting to input coordinates. This technology is described for instance in FIG. 2 in pages 2 to 3 in Japanese Patent Application Publication No. Hei 5-35402.

The touch panel shown in FIG. 20 determines a region (a blackened circle), where the photoreceptive devices to be a photosensor does not receive light, by use of coordinates, and then detects a position where the finger touches. Therefore, it is required to dispose a light source and a photosensor in a manner that on the display unit, the light emission from the light source is uniform and also there is no region where the light emission does not reach. If a precision to recognize a position on which a finger touches is attempted to be increased, it is generally required to dispose many light sources and photosensors in the circumference of the display area 302. Hence, the requirement has been a factor to hinder the miniaturization of a touch panel. Furthermore, there has been a problem such as variations in sensing sensitivity in a region where it is difficult for light to reach (for example, a point Z which is the farthest from a light source) and in the vicinity of the center.

Moreover, a conventional touch panel is manufactured in such a manner that a display area and a photosensor are fabricated as separate modules through separate manufacturing processes by use of separate plants. A finished product has been manufactured by assembling these modules in the same housing. Thus, there have naturally been limits to reduction in the number of parts in the equipment and to reduction in manufacturing cost of each module.

Particularly, a mobile terminal such as a PDA is remarkably prevalent at present. Hence, it is required that a touch panel should be further reduced in size, weight and thickness. In addition, it is also desired to reduce the number of parts and to provide a product at low price.

### SUMMARY OF THE INVENTION

The present invention provides a touch panel that includes a substrate, a display area comprising a plurality of display pixels disposed on the substrate, each of the display pixels comprising a light emitting circuit, a plurality of photosensor circuits disposed in the display area, a horizontal driving circuit and a vertical driving circuit that drive the light emitting circuits and the photosensor circuits, and a comparison circuit that is connected with the horizontal driving circuit and compares an output of one of the photosensor circuits with a predetermined standard.

The present invention also provides a touch panel that includes a substrate, a plurality of data output lines disposed on the substrate, a plurality of gate lines disposed on the substrate so as to intersect the data output lines, a display area comprising a plurality of display pixels disposed on the substrate, each of the display pixels comprising a light emitting circuit and being disposed adjacent a corresponding intersection of the data output lines and the gate lines, a plurality of photosensor circuits disposed in the display area, each of the photosensor circuits being disposed adjacent a corresponding intersection of the data output lines and the gate lines, a horizontal driving circuit selecting sequentially the data output lines, a vertical driving circuit supplying scan signals to the gate lines, and a comparison circuit that is connected with the horizontal driving circuit and compares an output of one of the photosensor circuits with a predetermined standard.

The present invention further provides a touch panel that includes, a substrate, a plurality of data output lines disposed on the substrate, a plurality of gate lines disposed on the substrate so as to intersect the data output lines, a display area comprising a plurality of display pixels disposed on the substrate, each of the display pixels comprising a light emitting circuit and being disposed adjacent a corresponding intersection of the data output lines and the gate lines, and a plurality of photosensor circuits disposed in the display area, wherein the photosensor circuits are configured to be scanned so as to identify positions of the display area in which corresponding photosensor circuits do not detect external light incident on the display area.

The present invention further provides a touch panel that includes a substrate, a plurality of data output lines disposed on the substrate, a plurality of gate lines disposed on the substrate so as to intersect the data output lines, a display area comprising a plurality of display pixels disposed on the substrate, each of the display pixels comprising a light emitting circuit comprising a drive transistor, an organic electroluminescent element and a selection transistor, a plurality of photosensor circuits disposed in the display area, each of the photosensor circuits comprising thin film transistors each connected with a corresponding data output line or a corresponding gate line, and a sensitivity adjustment circuit provided for each of the photosensor circuits and adjusting a light detecting sensitivity of a corresponding photosensor circuit, wherein the photosensor circuits are configured to be scanned so as to identify positions of the display area in which corresponding photosensor circuits do not detect external light incident on the display area.

### BRIEF DESCRIPTION OF THE DRAWINGS

FIGS. 1A to 1C are a plan view, a cross-sectional view and an exploded perspective view, respectively, for explaining a touch panel of a first embodiment of the present invention.

FIG. 2 is a circuit diagram for explaining the touch panel of the first embodiment of the present invention.

FIG. 3 is a cross-sectional view for explaining the touch panel of the first embodiment of the present invention.

FIGS. 4A and 4B are a plan view and a cross-sectional view, respectively, for explaining the touch panel of the first embodiment of the present invention.

FIG. 5 is a timing chart for explaining the touch panel of the first embodiment of the present invention.

FIGS. 6A to 6C are a plan view, a cross-sectional view and a schematic diagram, respectively, for showing a touch panel of a second embodiment of the present invention.

FIG. 7A is a circuit diagram explaining a display pixel of the second embodiment of the present invention.

FIG. 7B is a plan view of a phototransistor of the second embodiment of the present invention.

FIG. 7C is a cross-sectional view of the phototransistor of the second embodiment of the present invention.

FIG. 8 is a partial sectional view of the display pixel of the second embodiment of the present invention.

FIG. 9 is a circuit diagram explaining a photosensor of the second embodiment of the present invention.

FIGS. 10A to 10C are characteristics diagram explaining the photosensor of the second embodiment of the present invention.

FIGS. 11A to 11C are characteristics diagrams explaining the photosensor of the second embodiment of the present invention.

FIGS. 12A to 12C are circuit diagrams explaining the photosensor of the second embodiment of the present invention.

FIGS. 13A to 13C are circuit diagrams explaining the photosensor of the second embodiment of the present invention.

FIGS. 14A and 14B are a plan view and a cross-sectional view, respectively, for showing the touch panel of the second embodiment of the present invention.

FIGS. 15A and 15B are a plan view and a conceptual diagram, respectively, for explaining the phototransistor of the second embodiment of the present invention.

FIGS. 16A and 16B are cross-sectional views explaining touch panels of third and fourth embodiments of the present invention.

FIG. 17 is a circuit diagram explaining a display pixel of the third embodiment of the present invention.

FIGS. 18A and 18B are a plan view and a cross-sectional view, respectively, for explaining the touch panels of the third and fourth embodiments of the present invention.

FIG. 19 is a circuit diagram explaining a display pixel of the fourth embodiment of the present invention.

FIGS. 20A to 20C are a plan view, a cross-sectional view and a plan view, respectively, for explaining a conventional touch panel.

### DETAILED DESCRIPTION OF THE PREFERRED EMBODIMENTS

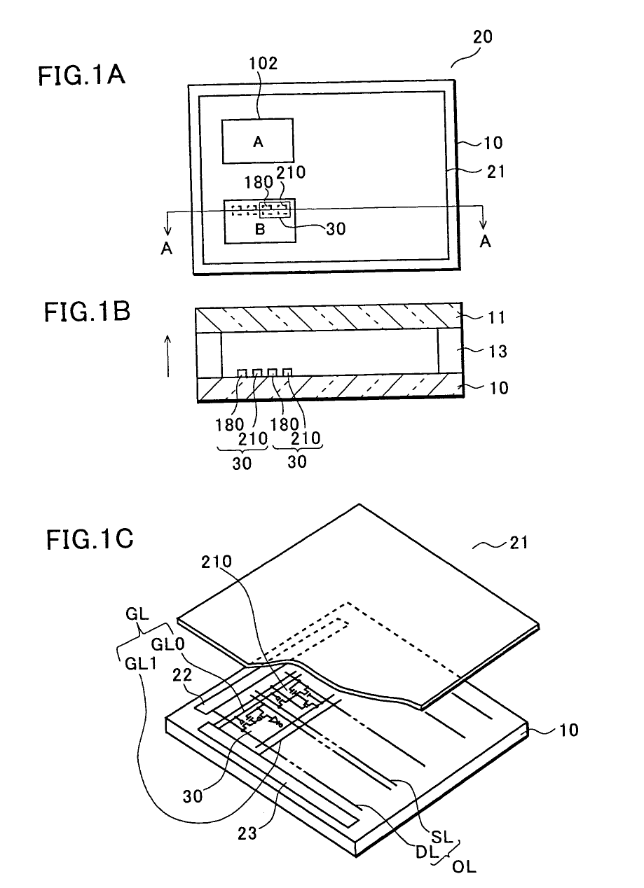

By use of FIGS. 1A to 19, descriptions will be given of embodiments of the present invention.

FIGS. 1A to 5 show a first embodiment of the present invention.

FIGS. 1A to 1C are schematic diagrams of a touch panel of this embodiment. FIG. 1A is a plan view, FIG. 1B is a schematic sectional view taken along the A-A line of FIG. 1A, and FIG. 1C is an exploded perspective view.

A touch panel 20 includes a display unit 21 in which display pixels 30 are disposed on a substrate 10 in a matrix form.

As shown in FIG. 1A, the substrate 10 is an insulating substrate made of glass or the like. Buttons 102 are displayed on the substrate 10 by use of the display pixels 30, for example, to let a user perform a given operation. An opposing substrate 11 is a transparent substrate made of glass or the like, through which the light from the display pixels 30 can pass. The opposing substrate 11 and the substrate 10 are fastened with a sealing agent 13 as shown in FIG. 1B. The display pixels 30 are disposed in a space hermetically sealed with the sealing agent 13. Each of the display pixels 30 has at least a light emitting circuit 180. In addition, a photoreceptor circuit (a photosensor) 210 are disposed adjacent to the light emitting circuit 180. The photosensor 210 is disposed in each of the display pixels 30.

The display pixel 30 is formed of an organic EL element, a transistor for driving the element and the like. The light, which is emitted upward as indicated with an arrow, passes through the transparent opposing substrate 11 which is provided in opposition to the substrate 10. Incidentally, although the opposing substrate 11, which is provided in opposition to the substrate 10, is shown in FIG. 1B, the opposing substrate 11 is not essentially required.

The photosensor 210 reads out a change in photocurrent caused by a touch of a user's finger, thus detecting that the button 102 is selected. Incidentally, detailed descriptions will be given of a touch panel operation later.

Furthermore, as shown in FIG. 1C, in the display unit 21 of the touch panel 20, a vertical driving circuit 23 and a horizontal driving circuit 22 are provided in the circumference of the substrate 10. Gate lines GL (GL0, GL1, and the like) and data output lines OL are connected to each circuit. Each of many display pixels 30 is disposed in the vicinity of each intersection of the lines. Note that although descriptions will be given later, the data output line OL is formed of a drain line DL and a sense data line SL.

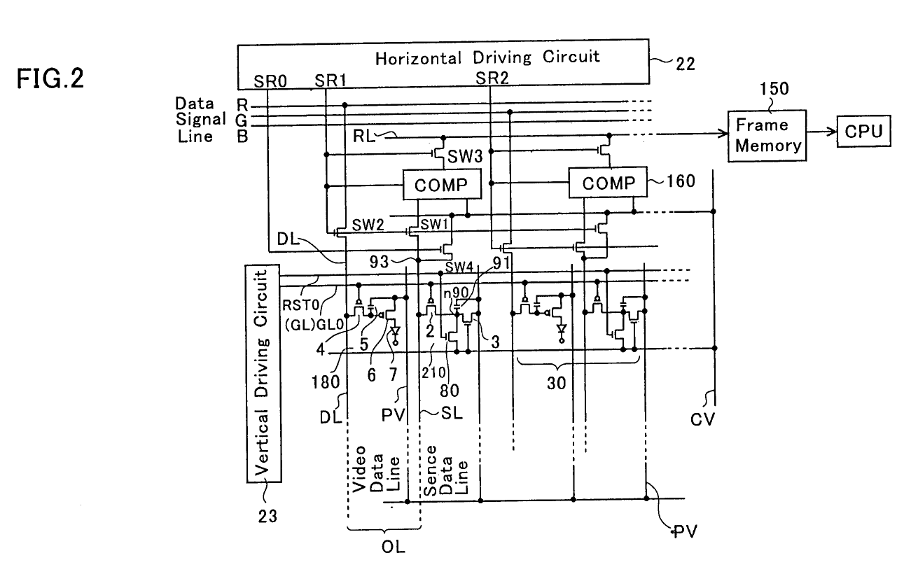

In FIG. 2, a circuit diagram of the touch panel 20 is shown. The circuit described in FIG. 2 is formed on the above-mentioned substrate 10. Incidentally, in this drawing, a combination of the light emitting circuit 180 and the photosensor 210, which have one row and two columns, are described, but the others are omitted. However, this application can be applied to a touch panel having m rows and n columns.

In addition, a first power supply line PV connected to the light emitting circuit 180 and a second power supply line CV connected to the photosensor 210 are disposed on the substrate 10. The first power supply line PV is connected to a first power source. The first power source is a drive power source, and is applied with a positive potential, for example. On the other hand, the second power supply line CV is connected to a second power source which is lower than the drive power source, and is applied with a potential having a standard voltage or below. The vertical driving circuit 23 and the horizontal driving circuit 22 are provided in the circumference of the substrate 10 which is to be the display unit 21.

The vertical driving circuit 23 is connected to the plurality of gate lines GL. The horizontal driving circuit 22 includes a plurality of shift resistors SR1, SR2 and the like. Each of the shift resistors is connected to a gate of a switch SW2 which turns on and off for the supply of data signals from data signal lines R, G and B, respectively. A drain of the switch SW2 is periodically connected to any one of the data signal lines R, G and B, and a source of the switch SW2 is connected to the drain line DL (a video data line), respectively.

Moreover, the shift resistor SR1 is connected to comparison circuits (a COMP) 160 for comparing a constant voltage and an output from the photosensor 210 which will described later, as well as being connected to gates of switches SW1 and SW3, which are connected to the COMP 160. The COMP 160 is connected to the second power supply line CV to which a constant voltage is applied, and also is connected to each one terminal of switches SW1 and SW3. The other terminal of the switch SW1 is connected to the sense data line SL, and the other terminal of the switch SW3 is connected to a data line RL. Furthermore, one terminal of a switch SW4 is connected to the second power supply line CV, the other terminal of the switch SW4 is connected to the sense data line SL and a gate of the switch SW4 is connected to a shift resistor SR0 which is prior to the shift resistor SR1 to which gates of switches SW1 to SW3 are connected.

The gate lines GL, the drain lines DL and the sense data lines SL, which have been described above, are disposed in a manner of intersecting with each other. In the vicinities of the intersections, the plurality of display pixels 30 are disposed in a matrix form.

A transistor of the display pixel 30 is a thin film transistor (hereinafter referred to as the TFT). The display pixel 30 is formed of a selection TFT 4, a drive TFT 6, an organic EL element 7 which are connected to the drive TFT 6 and a hold capacitor 5. The selection TFT 4 is disposed corresponding to each intersection of the gate lines GL and the drain lines DL, respectively. The selection TFT 4 has a gate electrode connected to the gate line GL, a drain connected to the drain line DL and a source connected to a gate electrode of the drive TFT 6. A source of the drive TFT 6 is connected to the first power supply line PV and a drain of the drive TFT 6 is connected to the organic EL element 7. Moreover, disposed are the plurality of gate lines GL extending in the row direction, and the plurality of drain lines DL and first power supply lines PV, which intersect with the gate lines GL in the column direction.

The photosensor 210 is formed of another selection TFT 2 and a TFT 3 to be a phototransistor, a reset TFT 80 and a hold capacitor 91. The selection TFT 2 is disposed in the vicinity of the intersection of the gate line GL and the sense data line SL. The selection TFT 2 has a gate electrode connected to the gate line GL, a drain connected to the sense data line SL and a source connected to a source of the phototransistor 3. The drain of the phototransistor 3 is connected to the first power supply line PV and a gate of the phototransistor 3 is connected to the second power supply line CV to which a constant off voltage equal to or less than the standard voltage is applied, for example.

In addition, one terminal of the reset TFT 80 is connected to the second power supply line CV, the other terminal of the reset TFT 80 is connected to a node n90 at the same potential as the source of the selection TFT 2, and a gate of the reset TFT 80 is connected to a reset line RST0 extending from the vertical driving circuit 23. One electrode to form the hold capacitor 91 is connected to the node n90 and the other electrode of the hold capacitor 91 is connected to the first power supply line PV. Moreover, disposed are the plurality of gate lines GL extending in the row direction and the plurality of sense data lines SL and first power supply lines PV, which extend in the column direction in a manner of intersecting with the gate lines GL.

Furthermore, the sense data line SL, to which the drain of the selection TFT 2 is connected, is provided with the comparison circuit (the COMP) 160. Thus, the standard voltage and the output voltage from the photosensor 210 are compared, thus outputting its signal as a detection value. One screenful of the detection values is stored by, for example, a frame memory 150 or the like, which is an external IC.

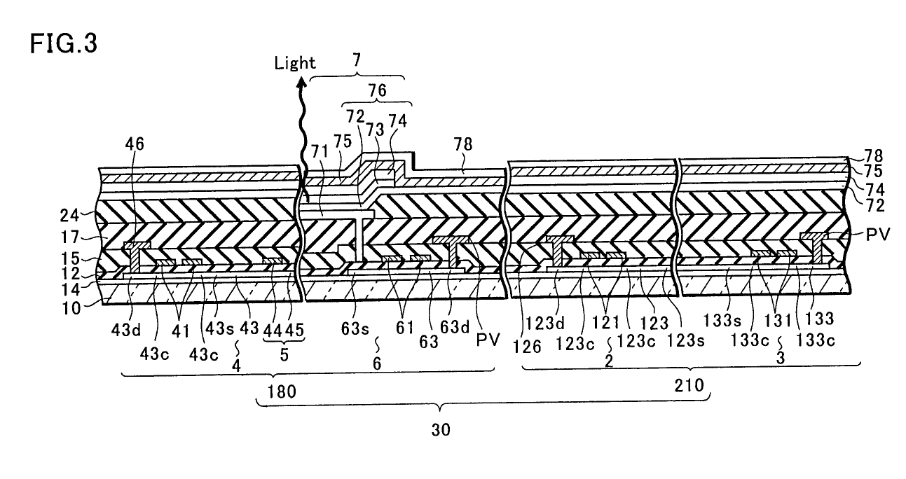

FIG. 3 shows an enlarged cross-sectional view of the light emitting circuit 180 and the photosensor 210. This is an enlarged view of the A-A line in FIG. 1A. In this embodiment, each constituent layer of the selection TFT 4 and the drive TFT 6, which constitute the display pixel 30, and the selection TFT 2 and the phototransistor 3, which constitute the photosensor 210, is formed in the same layer on the same substrate, respectively.

Firstly, the selection TFT 4 is provided with an insulation film (SiN, SiO₂ and the like) 14, which is to be a buffer layer, on the insulating substrate 10 made of silica glass, no-alkali glass or the like, and on top of it, a semiconductor layer 43 made of polycrystalline silicon (poly-silicon) film is formed. A gate insulation film 12 is laminated on the semiconductor layer 43, and thereon a gate electrode 41 made of refractory metal, such as chrome (Cr), molybdenum (Mo) or the like, is formed. In the semiconductor layer 43, an intrinsic or substantially intrinsic channel 43c, which is placed below the gate electrode 41, is provided. In addition, a source 43s and a drain 43d, which are n⁺ impurity diffusion regions, are provided on both sides of the channel 43c. Moreover, all over the gate insulation film 12 and the gate electrode 41, for example, a SiO₂ film, a SiN film, and a SiO₂ film are sequentially laminated to form an interlayer insulation film 15. A contact hole, which is formed in a position corresponding to the drain 43d of the interlayer insulation film 15, is filled with metal such as aluminum (Al) or the like to provide a drain electrode 46 integrally with the drain line DL.

Furthermore, a capacitance electrode line 44 is disposed in the same layer as the gate electrode 41. A capacitance electrode 45 formed of the semiconductor layer is provided with the gate insulation film 12 interposed therebetween. Thereby, the hold capacitor 5 is formed.

Similarly to the selection TFT 4, the drive TFT 6 is formed in the same layer as the constituent components of the selection TFT 4 on the substrate 10. In other words, the buffer layer 14, a semiconductor layer 63, the gate insulation film 12, a gate electrode 61 and the interlayer insulation film 15 are formed in the same layers as the corresponding constituent components of the selection TFT 4, respectively. The first power supply line PV, which is connected to the drive power source, is disposed in the same layer as the drain line DL.

Moreover, a planarizing insulation film 17 is disposed all over the surface, and then a first electrode 71 of the organic EL element 7 is disposed. The first electrode 71 is made of indium tin oxide (ITO) which makes contact with a source 53s and is an independent pixel electrode (an anode) in each of the display pixel 30. An insulation film 24, which covers the whole surface, is opened to expose the anode 71. A hole transport layer 72, which includes first and second hole transport layers, is formed all over the surface in a manner of covering over the anode 71, and thereon a luminescence layer 73 and an electron transport layer 74, which are independent in each of the display pixel 30, are provided. Note that the electron transport layer 74 may be formed all over the surface. An organic EL layer 76 is formed of the hole transport layer 72, the luminescence layer 73 and the electron transport layer 74. A cathode 75 made of aluminum alloy and a protective film 78 are disposed in a manner of covering all over the organic EL element 76. The cathode 75 is electrically connected to the second power source, and is an electrode common to each pixel 30 of the display unit 21. This cathode 75 and the protective film 78 are provided all over the substrate 10 to form an organic EL display device.

In the organic EL layer 76, holes injected from the anode 71 and electrons injected from the cathode 75 are recombined inside the luminescence layer 73, thus exciting organic molecules which form the luminescence layer 73. For this reason, an exciton occurs. In course of radiative deactivation of this exciton, light is emitted from the luminescence layer 73. This light is then released to the outside from the transparent anode 71 through the transparent insulating substrate 10. Thus, the organic EL layer 76 emits light.

Furthermore, similarly to the selection TFT 4 of the display pixel 30, the selection TFT 2 to be constituted of the photosensor 210, too, is formed in the same layer on the substrate 10. In other words, the buffer layer 14, a semiconductor layer 123, the gate insulation film 12, a gate electrode 121 and the interlayer insulation film 15 are formed in the same layer as the selection TFT 4, respectively. Then, a drain electrode 126 is formed integrally with the sense data line SL. Note that similarly to the drive TFT 6, the phototransistor 3 is formed of the buffer layer 14, a semiconductor layer 133, the gate insulation film 12, a gate electrode 131, and is connected to the first power supply line PV.

When external light enters the semiconductor layer 133 of the phototransistor 3 in an off state, electron-hole pairs are generated in a junction region between a channel 133c and a source 133s or between the channel 133c and a drain 133d. These electron-hole pairs are separated due to the electric field in the junction region, thus generating photovoltaic force. Accordingly, the photocurrent is obtained.

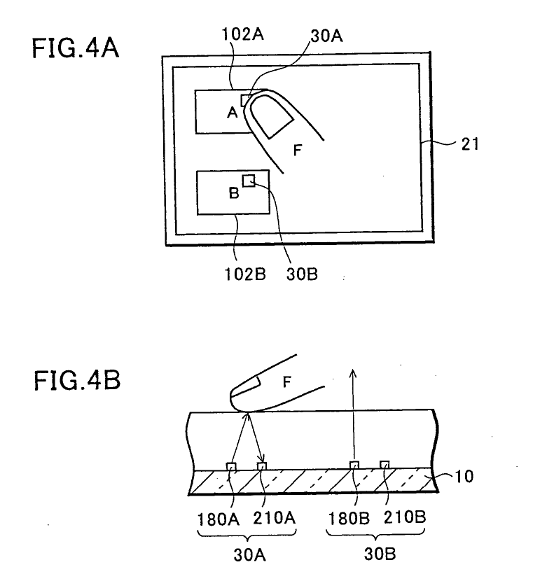

Here, by use of FIGS. 4A and 4B, descriptions will be given of the operational principle of the touch panel 20 of the embodiment. The touch panel 20 displays images such as the buttons 102 to let a user select a predetermined process by use of the plurality of display pixels 30. If the user touches a button 102A to perform the predetermined process (see FIG. 4A), the light of a display pixel 30A which emits light upward in the page space is reflected by a finger F. The reflected light is incident to a photosensor 210A which is disposed in a manner of corresponding to the button 102A (the display pixel 30A). On the other hand, the light of a display pixel 30B corresponding to a button 102B, which the finger F is not selecting, passes upward. Thus, the reflected light is not incident to a photosensor 210B disposed in a manner of corresponding to the button 102B. In this manner, the photosensor 210 detects the presence or absence of the reflected light, thus detecting whether the finger F is selecting the button 102.

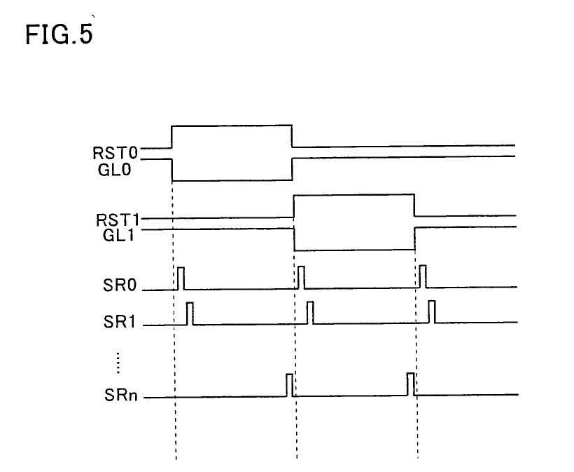

Next, with reference to the above-mentioned FIG. 2 and FIG. 5 in which a timing chart is illustrated, descriptions will be given of the circuit operation of the touch panel 20 of the embodiment.

Firstly, when a signal at H (High) level is supplied to the reset line RST0, all the reset TFTs 80 which are connected to the reset line RST0 are turned on. Thus, the nodes n90 become the same potential as that of the second power supply line CV. In other words, the phototransistors 3, which correspond to the reset line RST0, are resetted. As well as supplying the H level signal to the reset line RST0, a signal at L (Low) level is supplied to the gate line GL0 concurrently. Therefore, the selection TFT 4 in each of the display pixels 30 and the selection TFT 2 in each of the photosensors 210, the selection TFTs 4 and 2 being connected to the GL0, are turned on. Next, when the signal at H level is outputted from the shift resistor SR0, the switch SW 4 connected to the shift resistor SR0 is turned on. Hence, the potential of the sense data line SL becomes the same as that of the second power supply line CV. Specifically, the sense data line SL is resetted.

Subsequently, when the signal at H level is outputted from the shift resistor SR1, since the switch SW2 is turned on, a data signal is supplied from the data signal line R to the drain line DL. The gate of the drive TFT 6 is applied with the signal through the selection TFT 4. Accordingly, a current from the first power supply line PV is supplied to the organic EL element 7 in response to the signal.

When the button 102 is selected, the light emitted from the organic EL element 7 is reflected by the finger F and the reflected light then enters the photosensor 210. That is, the potential of the node n90 increases more than that of the second power supply line CV due to a voltage equivalent to a photocurrent of the reflected light. On the other hand, when the button 102 is not selected, the photosensor 210 does not detect the reflected light. Accordingly, the potential of the node n90 remains the same as that of the second power supply line CV. This potential of the node n90 becomes sensing data.

When the switch SW1 is turned on at the same time as the switch SW2, the potential of the node n90 is outputted as the sensing data from the phototransistor 3 to the COMP 160 through the selection TFT 2 and the switch SW1. When the switches SW1 and SW2 are turned on, the switch SW3, too, is turned on simultaneously. Therefore, a signal is outputted to the data line RL according to a result obtained by comparing the sensing data inputted to the COMP 160 and the potential of the second power supply line CV. The signal is the detection value and is written in the frame memory 150.

Furthermore, the switch SW4 in the next column is turned on. Thus, the sense data line SL in the next column is resetted to have the same potential as the second power supply line CV.

Hereinafter, similarly, the sense data lines SL and the drain lines DL are sequentially selected, thus driving the display pixels 30 and the photosensors 210 in one row. Thereafter, the vertical driving circuit sequentially switches to the gate line GL1 in the next row and selects the line. Then, the vertical driving circuit displays the equivalence of one screen by selecting until the last row. Moreover, one screenful of the output (the detection value) from the COMP 160 is accumulated in the frame memory 150 or the like, such as an external IC. Thus, the presence or absence of a touch and its position can be detected.

Incidentally, although the comparison circuit 160 may be provided individually for each display pixel 30, since, as described above, the comparison circuit 160 is operated at the same time as the selection of each of the display pixel 30, there may be one comparison circuit 160 for one screen. Note that since a photocurrent generated in the phototransistor 3 is a very small current, it is preferable to dispose the comparison circuit 160 as close to the phototransistor 3 as possible in order to avoid the attenuation. Moreover, in terms of each display pixel 30, since the distance between each pixel is to increase, it is suitable to provide the comparison circuit 160 in a manner of corresponding to the photosensors 210 in one column.

As described above, the descriptions have been given of the case where the photosensors 210 are disposed in a manner of corresponding to each display pixel 30 in the first embodiment. However, the plurality of adjacent display pixels 30 may be configured to be disposed for one photosensor 210. Specifically, there may be some display pixels 30 in which the photosensor 210 is not disposed. The touch panel 20 can sufficiently detect a touch as long as an area where the finger F touches is one square mm. Accordingly, it is possible to perform sensing, for example, by use of one photosensor 210 for four pixels or one photosensor 210 for nine pixels.

In addition, the descriptions have been given of the top emission structure where light is emitted to the opposing substrate 11 side (upward) from the substrate 10 on which the TFTs are disposed. However, the embodiment can be implemented similarly by use of a bottom emission structure where light is emitted downward through the substrate 10.

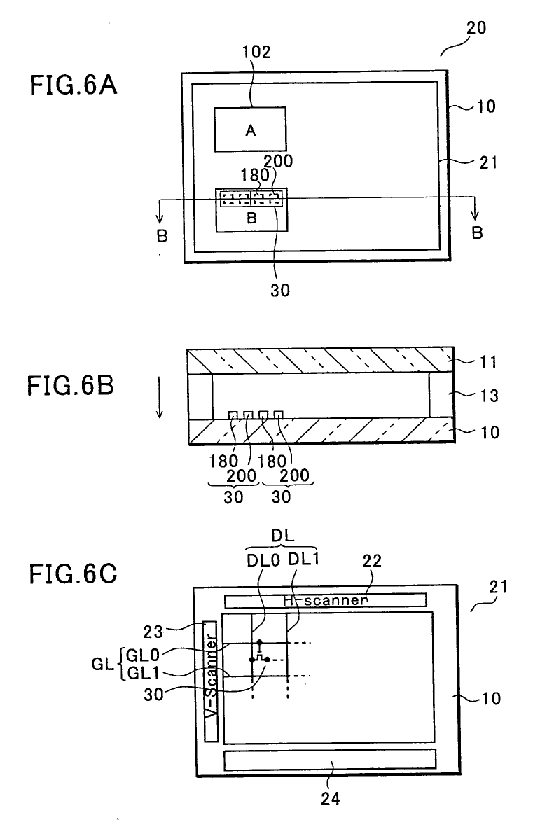

Next, descriptions will be given of a second embodiment, taking a touch panel using an organic EL element of an active matrix type as an example, with reference to FIGS. 6A to 15B.

FIGS. 6A to 6C are schematic diagrams showing a touch panel of this embodiment. FIG. 6A is a plan view and FIG. 6B is a schematic sectional view taken along the B-B line in FIG. 6A. FIG. 6C is a schematic diagram of the inside of a display unit.

A touch panel 20 is formed of a display unit 21 in which display pixels 30 are disposed on a substrate 10, and an opposing substrate 11 provided in opposition to the substrate 10. Note that although the opposing substrate 11 is shown in FIG. 6B, the opposing substrate 11 is not essentially required in the second embodiment.

As shown in FIGS. 6A and 6B, the substrate 10 is an insulating substrate such as glass. Buttons 102 are displayed by the display pixels 30 on the substrate 10, for example, to let a user perform a predetermined operation. The opposing substrate 11 is a transparent substrate made of glass or the like through which light from the display pixels 30 passes. The opposing substrate 11 and the substrate 10 are fastened, for example, with a sealing agent 13 or the like. The display pixels 30 are disposed in an internal space which is thereby hermetically sealed. Each of the display pixels 30 has a light emitting circuit 180 formed of an organic EL element. In addition, at least part of the display pixels 30 have a photoreceptor circuit (a photosensor) 200 therein. The light emitting downward (in the substrate 10 direction) as indicated with an arrow passes through the transparent substrate 10, and the user perceives the buttons 102 from the substrate 10 direction. The photosensor 200 reads out a change in photocurrent due to a touch of the user's finger, thus detecting which one of the buttons 102 has been selected. Detailed descriptions will be given of the operation of the touch panel later.

As shown in FIG. 6C, drain lines DL (DL0, DL1 and the like) and gate lines GL (GL0, GL1 and the like) are disposed on the substrate 10 of the display unit 21. The display pixels 30 are connected to the vicinities of the intersections, respectively, thus disposing the lines in a matrix form. Additionally, the light emitting circuit (not shown here) of the display pixel 30 is formed of an organic EL element having a luminescence layer between an anode and a cathode, a drive transistor of the organic EL element and a selection transistor. Both the drive transistor and the selection transistor are TFTs.

Furthermore, the photosensor (not shown here) provided in each of the display pixels 30 is a photoreceptor circuit including TFTs. A photocurrent is obtained due to the light which is irradiated when the TFTs are off.

On sides of the display unit 21, a horizontal driving circuit 22, which sequentially selects the drain lines DL extending in the column direction, is disposed, and a vertical driving circuit 23, which sends scanning signals (gate signals) to the gate lines GL extending in the line direction, is disposed. Further, unillustrated lines which transmit various signals inputted to the gate lines GL, the drain lines DL and the like are gathered to a side of the substrate 10, and are connected to an external connector 24.

In addition, the display unit 21 is connected to an external integrated circuit which is not shown. The external integrated circuit controls the display unit 21, for example, by outputting a data signal Vdata to the display unit 21 and causing the organic EL element to emit light by applying a drive voltage to a TFT connected to the organic EL element.

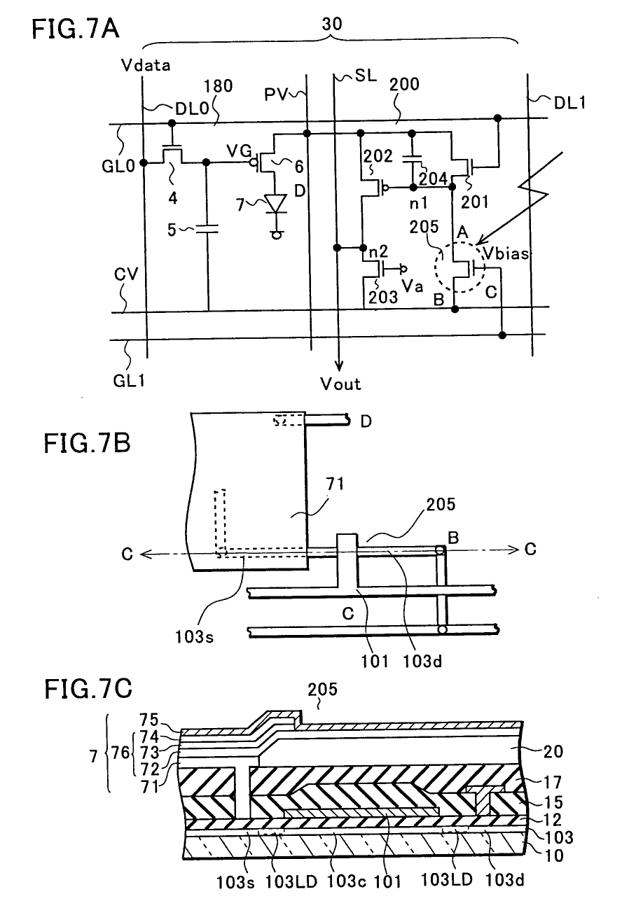

With reference to FIGS. 7A to 7C, descriptions will be given of the display pixel 30 of the embodiment. FIG. 7A is a circuit diagram showing one pixel. FIG. 7B is a plan view of an encircled area in FIG. 7A, and terminals A, B, C and D corresponding to those in the circuit diagram of FIG. 7A are shown in FIG. 7B. Additionally, FIG. 7C is a cross-sectional view taken along the C-C line in FIG. 7B. Incidentally, FIG. 7B is the plan view when viewed from the substrate 10 side.

The photoreceptor circuit 200 to be the photosensor is connected to the light emitting circuit 180 of the display pixel 30. On the substrate 10, disposed are the plurality of gate lines GL (GL0, GL1 and the like) extending in the row direction, and the plurality of drain lines DL (DL0, DL1 and the like) and a first power supply line PV, which extend in the column direction in a manner of intersecting with the gate lines GL. The first power supply line PV is connected to a first power source. The first power source is a power source for outputting, for example, a positive constant voltage.

The light emitting circuit 180 includes a selection TFT 4, a hold capacitor 5, a drive TFT 6 and an organic EL element 7, which are connected to each intersection of the gate lines GL and the drain lines DL. A gate of the selection TFT 4 is connected to the gate line GL, and a drain of the selection TFT 4 is connected to the drain line DL. A source of the selection TFT 4 is connected to the hold capacitor 5 and a gate of the drive TFT 6.

A drain of the drive TFT 6 is connected to the first power supply line PV, and a source of the drive TFT 6 is connected to an anode of the organic EL element 7. A cathode of the organic EL element 7 is connected to a second power source. The second power source is a power source to output a negative constant voltage. A second power supply line CV, which is connected to the second power source and extends in the column direction, is connected to the counter electrode of the hold capacitor 5.

The first power supply line PV is connected to the first power source. That is, the drive TFT 6 is connected to the first power supply line PV and the organic EL element 7 with conductivity depending on the magnitude of the data signals Vdata. As a result, a current in response to the data signals Vdata is supplied from the first power supply line PV through the drive TFT 6 to the organic EL element 7. Accordingly, the organic EL element 7 emits light with a brightness in response to the data signal Vdata.

The hold capacitor 5 has a capacitance between other electrodes such as the second power supply line CV or the first power supply line PV, and can store the data signals for a certain period of time.

The vertical driving circuit 23 selects another gate line GL1 after unselecting the gate line GL0. Even after the previously selected gate line GL0 becomes unselected and the selection TFT 4 is turned off, the data signals Vdata are held by the hold capacitor 5 during one vertical scanning period. In the meantime, the drive TFT 6 holds the conductivity, thus enabling the organic EL element 7 to continue to emit light with the brightness.

The drive TFT 6 and the organic EL element 7 are connected in series between the positive first power source and the negative second power source. A drive current flowing to the organic EL element 7 is supplied from the first power source through the drive TFT 6 to the organic EL element 7, and the drive current can be controlled by changing a gate voltage VG of the drive TFT 6. As described above, the data signals Vdata are inputted to the gate electrode, and the gate voltage VG thus has a value corresponding to the data signal Vdata.

The photoreceptor circuit 200 to be the photosensor includes a phototransistor 205, a capacitor 204, a first switching transistor 201, a second switching transistor 202, a node n1, a node n2 and a resistor 203, and the photoreceptor circuit 200 is connected to the gate lines GL, the power supply line PV, the second power supply line CV and a sense data line SL of the light emitting circuit 180 in each of the light emitting pixel 30. The sense data line SL is connected to one terminal of a resistor 203 of the photoreceptor circuit 200, thus outputting a detection result (output voltage Vout) of the photoreceptor circuit (photosensor) 200 to the external integrated circuit. Note that the potential of the second power supply line CV is lower than that of the first power supply line PV. In addition, the hold capacitor 5 is connected to the second power supply line CV, but a specialized capacity line (unillustrated) may be provided to be connected to the hold capacitor 5. In addition, the detailed description of the photoreceptor circuit 200 will be described later.

With reference to FIGS. 7B and 7C, a description will be given of the phototransistor 205 including the photosensor 200.

In the phototransistor 205, a semiconductor layer 103 made of a p-Si (poly-silicon) film is laminated on the insulating substrate 10 made of silica glass, no-alkali glass or the like. This p-Si film may be formed by laminating an amorphous silicon film, and recrystallizing the film by laser annealing or the like.

On the semiconductor layer 103, a gate insulation film 12 made of SiN, SiO₂ or the like is laminated, and thereon a gate electrode 101 made of refractory metal, such as chrome (Cr), molybdenum (Mo) or the like, is formed. In the semiconductor layer 103, an intrinsic or substantially intrinsic channel 103c which is located below the gate electrode 101 is provided. In addition, a source 103s and a drain 103d are provided on both sides of the channel 103c, which are n⁺ impurity diffusion regions.

In a p-Si TFT having a structure of this kind, when the TFT is off, if the external light enters the semiconductor layer 103 (from the substrate 10 direction), electron-hole pairs are generated in a junction region between the channel 103c and the source 103s or between the channel 103c and the drain 103d. These electron-hole pairs are separated due to the electric field in the junction region, thus generating photovoltaic force. Accordingly, the photocurrent is obtained, which is outputted from the source region 103s side, for example. That is, this photocurrent is a dark current of when the TFT is off. By detecting the increase of the dark current, a p-Si TFT with the above structure is used as a photosensor.

Here, the semiconductor layer 103 may be provided with a low concentration impurity region. The low concentration impurity region means a region which is provided adjacent to the source 103s or the drain 103d on the channel 103c side, and which is lower in impurity concentration compared to the source 103s or the drain 103d. By providing this region, it is made possible to relax the electric field concentrated at the edge of the source 103s (or the drain 103d). The width of the low concentration impurity region is approximately 0.5 μm to 3 μm, for example.

In this embodiment, a low concentration impurity region 103LD is provided, for example, between the channel 103c and the source 103s (or between the channel 103c and the drain 103d) to form a so-called light doped drain (LDD) structure. With the LDD structure, it is possible to increase, in the direction of a gate length L, the junction region contributing to photocurrent generation, so that photocurrent generation occurs more readily. That is, it is advantageous that the low concentration impurity region 103LD is provided at least on the drain side in terms of the photocurrent. In addition, by adopting the LDD structure, the off characteristics (the detection region) of Vg-Id characteristics is stabilized, and a stable device can be obtained.

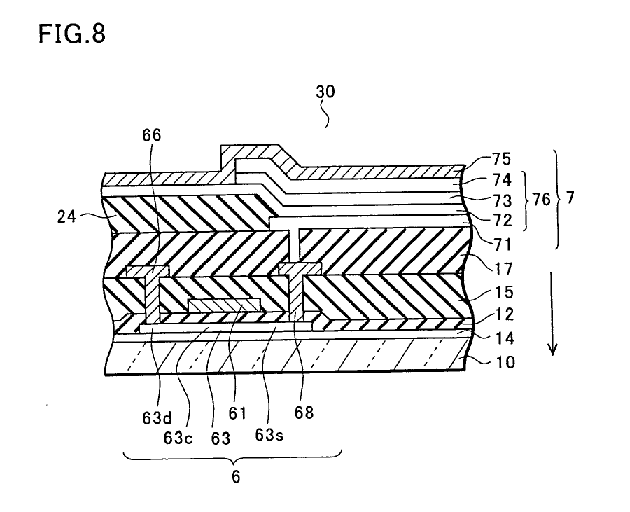

FIG. 8 is a cross-sectional view of a part of the light emitting pixel 30, and shows a part of the drive TFT 6 and of the organic EL element 7.

In the display pixel 30, an insulation film (made of SiN, SiO₂ or the like) 14, which serves as a buffer layer, is provided on the insulating substrate 10 made of silica glass, no-alkali glass or the like, and thereon a semiconductor layer 63 made of a p-Si (poly-silicon) film is laminated. This p-Si film may be formed by laminating an amorphous silicon film, and recrystallizing the film by laser annealing or the like.

On the semiconductor layer 63, a gate insulation film 12 made of SiN, SiO₂ or the like is laminated, and thereon a gate electrode 61 made of refractory metal, such as chrome (Cr), molybdenum (Mo) or the like, is formed. In the semiconductor layer 63, an intrinsic or substantially intrinsic channel 63c which is located below the gate electrode 61 is provided. In addition, the drive TFT 6 is composed by providing a source 63s and a drain 63d, which are n⁺ impurity diffusion regions on both sides of the channel 63c. Note that although the illustration is omitted, the selection TFT has a similar structure to that of the drive TFT 6 (with reference to FIG. 3).

All over the gate insulation film 12 and the gate electrode 61, a SiO₂ film, a SiN film, and a SiO₂ film, for example, are sequentially laminated to form an interlayer insulation film 15. In the gate insulation film 12 and the interlayer insulation film 15, contact holes are provided, corresponding to the drain 63d and the source 63s. The contact holes are filled with metal, such as aluminum (Al) or the like, to provide a drain electrode 66 and a source electrode 68, which are brought into contact with the drain 63d and the source 63s, respectively. On a planarizing insulation film 17, an anode 71 is provided to serve as a pixel electrode such as indium tin oxide (ITO). The anode 71 is connected to the source electrode 68 (or the drain electrode 66) by use of contact holes provided in the planarizing insulation film 17.

The organic EL element 7 is formed by providing an organic EL layer 76 on the anode 71 and further forming a cathode 75 made of an alloy of magnesium and indium. The anode is the independent pixel electrode for each of the display pixel 30 and the cathode 75 is a common electrode for each of the pixel 30 of the display unit 21. The organic EL layer 76 is formed by sequentially laminating a hole transport layer 72, a luminescence layer 73 and an electron transport layer 74. This cathode 75 is provided all over the display unit 21 shown in FIG. 6.

In addition, in the organic E1 element 7, holes injected from the anode 71 and electrons injected from the cathode 75 are recombined inside the luminescence layer 73, thus exciting organic molecules which form the luminescence layer 73. For this reason, an exciton occurs. In course of radiative deactivation of this exciton, light is emitted from the luminescence layer 73. This light is then released from the transparent anode 71 through the transparent substrate 10 to the outside. Thus, the organic EL element 7 emits light. Note that a bottom emission structure to emit light toward the substrate 10 is employed in this embodiment as an example.

In this manner, in the case where the display pixel 30 has a bottom emission structure, the photosensor 200 detects a change in external light quantity, the change being caused by a touch/non-touch of a finger which is placed on the substrate 10. Therefore, it is desired for the phototransistor 205 to have a top gate structure where the gate electrode 101 is disposed above the semiconductor layer 103 in order to enable the external light from the substrate 10 direction to enter the semiconductor layer 103 directly. (See FIG. 7C.)

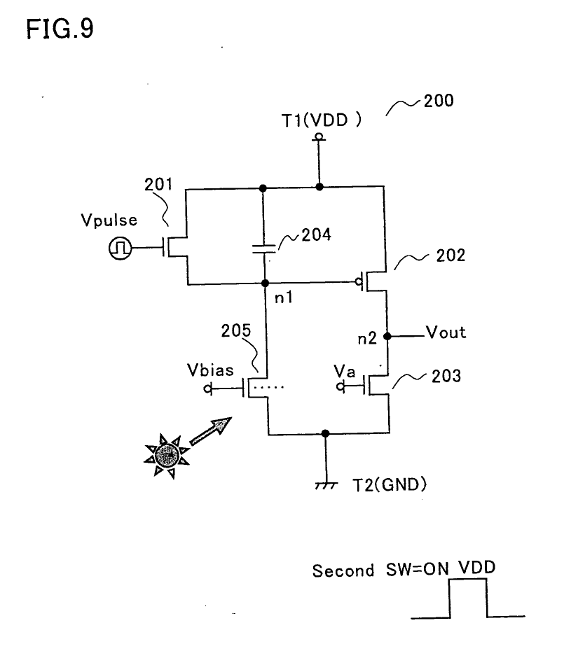

With reference to FIGS. 9 to 11, a description will be given of the photosensor 200.

FIG. 9 is a circuit diagram showing a taken out part from the circuit diagram of FIG. 7A which is a photoreceptor circuit to be the photosensor 200. The photosensor 200 includes the phototransistor 205, the capacitor 204, the first switching transistor 201, the second switching transistor 202, the node n1, the node n2, the resistor 203, a first power supply terminal T1 and a second power supply terminal T2.

It is sufficient if the first power supply terminal T1 has a higher voltage than the second power supply terminal T2. Here, a description will be given, assuming that the first power supply terminal T1 is a VDD potential and the second power supply terminal T2 is a GND potential as an example.

The first switching transistor 201 is brought into conduction by use of an input of an input signal (voltage) Vpulse to a control terminal thereof. The first switching transistor 201 is connected in series to the phototransistor 205. Both are connected between the first power supply terminal T1 and the second power supply terminal T2.

Further, the second switching transistor 202 and the resistor 203 are connected in series. These are also connected between the first power supply terminal T1 and the second power supply terminal T2.

One terminal of the capacitor 204 is connected to a control terminal of the second switching transistor 202 by use of the node n1, and the other terminal is connected to the first power supply terminal T1 or the second power supply terminal T2. The capacitor 204 is charged by bringing the first switching transistor 201 into conduction. The potential of the node n1 is thus changed.

Hereinafter, a description will be given in detail. The one terminal of the capacitor 204 is connected to an output terminal of the phototransistor 205 by use of the node n1, and the other terminal is connected to the first power supply terminal T1. The first switching transistor 201 is connected in parallel to the capacitor 204. Pulses are inputted to the control terminal of the first switching transistor 201 for a certain period of time.

The second switching transistor 202 is connected in series between the first power supply terminal T1 and the second power supply terminal T2. The output from the node n1 is applied to the control terminal of the second switching transistor 202. As an example, the first switching transistor 201 is an n-channel type TFT, and the second switching transistor 202 is a p-channel type TFT. Their structures are the same as that of the drive TFT 6 in FIG. 8.

One terminal of the resistor 203 is connected to one terminal of the second switching transistor 202 by use of the node n2, and the other terminal is connected to the second power supply terminal T2 and is grounded. The resistor 203 is, for example, a p-channel type TFT, and a control terminal thereof is applied with a constant voltage Va. If the gate voltage Va is fixed in a manner that a resistance between a source and drain of the TFT is high, it is possible to use the TFT as a resistance. Consequently, a photocurrent sensed at the phototransistor 205 is converted into a voltage, which is then outputted from the node n2. The voltage outputted due to a change in the constant voltage Va is changed, too. Note that a resistance value between the source and the drain of the resistor (TFT) 203 is approximately 10³ Ω to 10⁸ Ω in this case.

In this manner, by connecting the resistor 203 having a high resistance value between the first power supply terminal T1 and the second power supply terminal T2, the photocurrent sensed at the phototransistor 205 can be outputted as a divided voltage of a potential difference between a power supply potential VDD and a ground potential GND. A voltage between the first power supply terminal T1 and the second power supply terminal T2 may be set within a range where its use as a feedback is easy. Incidentally, a change of the constant voltage Va and a detail description of the circuit operation will be given later.

Note that, in this embodiment, it is suitable to relax the electric field concentrated at the end of a source (or a drain) if the first and second switching transistors 201 and 202 also have a so-called LDD structure.

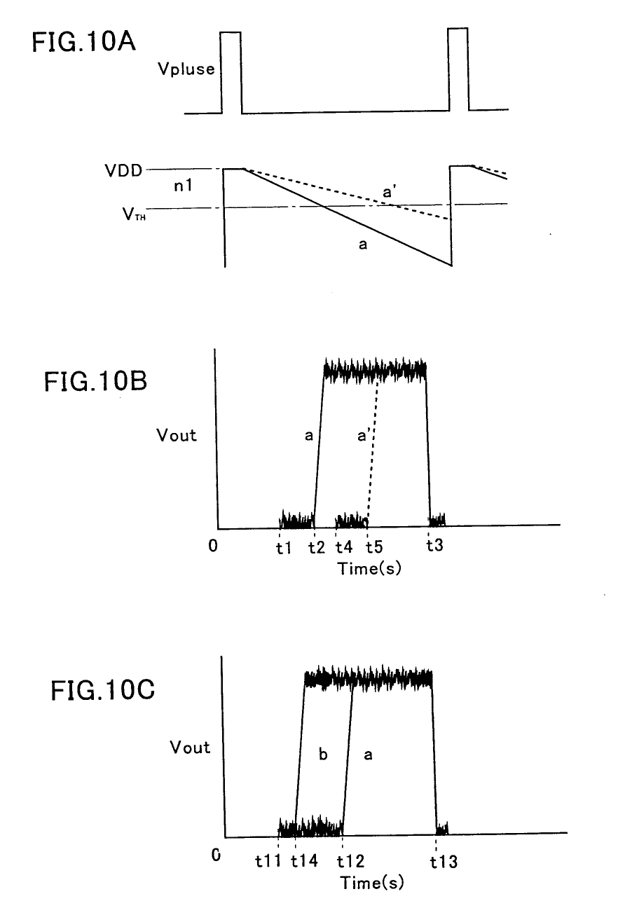

With reference to FIG. 10, a description will be given of the operation of the photosensor 200. FIG. 10A is a timing chart and FIGS. 10B and 10C are the examples of the output voltages Vout.

Pulses of a predetermined voltage Vpulse (H level) are inputted to the control terminal, that is, the gate electrode, of the first switching transistor 201 for a certain period of time. While the H level pulses are being inputted, the conduction of the first switching transistor 201 is maintained. Accordingly, the capacitor 204 is charged with electric charges of the power supply potential VDD.

When the pulses fall to L level (0 V), the first switching transistor 201 is cut off. In this embodiment, the standard potential (VDD potential) is set to be the potential of the node nil, and the output voltage is obtained by causing the potential of the node n1 to decrease due to the discharge from the phototransistor 205.

When the phototransistor 205 is irradiated with light, a very small photocurrent of, for example, approximately 10⁻¹⁴ A to 10⁻⁹ A is outputted. As described above, the photocurrent is a dark current to be generated depending on light quantity irradiated when a TFT, which composes the phototransistor 205, is off. In other words, a current leaking from the phototransistor 205 due to light is sensed, thus detecting the light quantity. Therefore, if the phototransistor 205 is irradiated with light, electric charges are discharged from the phototransistor 205 depending on the light quantity, and the standard potential (VDD potential) of the node n1 falls as shown in FIG. 10A with a solid line a.

The second switching transistor 202 is a p-channel type TFT, and a control terminal (gate electrode) thereof is connected to the node n1. That is, if the potential of the node n1 decreases to the threshold voltage VTH or under, the second switching transistor 202 is brought into conduction.

The resistor 203 is in conduction by use of the constant voltage Va, and a channel is formed depending on the constant voltage Va. Thus, it can be considered to be a resistor with a constant resistance value. The output voltage Vout is outputted by dividing the potential difference between the first power supply terminal T1 and the second power supply terminal T2 with the resistance values of the second switching transistor 202 and the resistor 203. In other words, before the second switching transistor 202 is brought into conduction, the resistance value of the second switching transistor 202 is sufficiently larger than that of the resistor 203, and the potential of the node n2 thus draws closer to that of the second power supply terminal T2. To the contrary, after the second switching transistor 202 is brought into conduction, the resistance value of the second switching transistor 202 becomes sufficiently smaller than that of the resistor 203, and the potential of the node n2 thus draws closer to that of the first power supply terminal T1.

Specifically, the photocurrent sensed at the phototransistor 205 can be detected as the output voltage Vout whose value is close to that of the power supply potential VDD, by dividing the potential difference between the power supply potential VDD and the ground potential GND.

Here, since the resistance value of the resistor 203 is very high, it is possible to obtain the output voltage Vout whose value is reasonably large to the extent of providing a feedback easily even if the photocurrent is very small.

In this manner, the photosensor 200 can be operated by simply inputting a pulse of the voltage Vpulse to the first switching transistor 201. Moreover, the photosensor 200 can be also realized with the components of only three TFTs and one capacitor for the circuit formation. Thus, the number of parts can be reduced.

FIGS. 10B and 10C show examples of outputting the output voltage Vout by use of light quantity. The x-axes in the graphs indicate time and the y-axes indicate the output voltages Vout. The solid line a and the dashed line a′ show a case where the constant voltages Va of the resistor 203 are the same value, but light quantity detected at the phototransistor 205 is different. The solid lines a and b show a case where the constant voltages Va of the resistor 203 differ from each other.

The relation between the light quantity, the value of the constant voltage Va (Va value) of the resistor 203 and the time for the output voltage Vout to be outputted becomes clear from these graphs.

First, with reference to FIG. 10B, descriptions will be given of a case (solid line a) where light quantity is larger and a case (dashed line a′) where light quantity is smaller. In both cases, the Va values are the same.

As described above, the potential of the node n1 increased to the standard potential VDD by use of the input signals (voltage) Vpulse decreases depending on light quantity sensed at the phototransistor 205 (solid line a in FIG. 10A). Then, the voltage decreases to under the threshold voltage of the second switching transistor 202. When the second switching transistor 202 is turned on, a current flows from the first power supply terminal T1 to the resistor (TFT) 203 (t1 in FIG. 10B). The channel is formed in the resistor 203 depending on the gate voltage Va, and the current flowing to the resistor 203 reaches saturation after a predetermined period elapsed. For this reason, the resistor 203 comes to have a constant resistance value. At that time, as a divided voltage of the power supply potential VDD and the resistor 203, the output voltage Vout can be detected at the node n2 (t2 in FIG. 10B).

Further, after a certain period elapsed, if the voltage Vpulse is inputted to the first switching transistor 201, the second switching transistor 202 is turned off. Hence, the output voltage Vout is substantially 0 V (t3). In other words, the output voltage Vout can be detected in binary as a time during which the output voltage Vout is detected (H level) and a time during which the output voltage Vout is not detected (L level).

When the light quantity is small as shown with the dashed line a′, the discharge amount from the phototransistor 205 becomes small. Accordingly, the time for the dashed line a′ to reach the threshold voltage of the second switching transistor 202 becomes later than that for the solid line a. That is, the timing for the second switching transistor 202 to be turned on becomes later (t4), and the timing for the output voltage Vout to reach H level becomes later (t5). The second switching transistor 202 is turned off by use of Vpluse inputted to the first switching transistor 201 at certain intervals. Then, the output voltage Vout falls to L level (t3). The time until the current flowing in the resistor 203 reaches saturation is substantially constant. Therefore, the delay for the second switching transistor 202 to be turned on indicates shortening the period during which the output voltage Vout stays H level.

Moreover, the longer the period to stay at H level is, the longer the time during which the output voltage Vout can be detected is. Accordingly, this means that the sensitivity as a photosensor is excellent. Therefore, the sensitivity of the photosensor 200 can be changed depending on small or large light quantity (solid and dashed lines a and a′).

Next, with reference to FIG. 10C, descriptions will be given of a case where the Va value is large (solid line a) and a case where the Va value is small (solid line b). In both cases, the light quantity is the same.

As described above, the potential of the node nil is increased to the standard potential VDD by inputting the input signals (voltages) Vpulse decreases depending on the light quantity sensed at the phototransistor 205 (solid line a in FIG. 10A). The potential of the node n1 falls to under the threshold voltage of the second switching transistor 202, thus causing the second switching transistor 202 to be turned on. Then, the current flows from the first power supply terminal T1 to the resistor (TFT) 203 (t11 in FIG. 10C). The channel is formed in the resistor 203 depending on a larger gate voltage Va1. After a certain period elapsed, the flowing current reaches saturation. For this reason, the resistor 203 comes to have a constant resistance value. At that time, as a divided voltage of the power supply potential VDD and the resistor 203, the output voltage Vout can be detected at the node n2 (t12 in FIG. 10C).

After a certain period further elapsed, if the voltage Vpulse is inputted to the first switching transistor 201, the second switching transistor 202 is turned off. Hence, the output voltage Vout becomes substantially 0 V (t13). In other words, the output voltage Vout can be detected in binary as a time during which the output voltage Vout is detected (H level) and a time during which the output voltage Vout is not detected (L level).

As shown with the solid line b, when the Va value is small (Va2), if the light quantity is the same, a time to reach the threshold voltage of the second switching transistor 202 is substantially the same as that of the solid line a. Therefore, timing for the second switching transistor 202 to be turned on is the same (t11).

When the second switching transistor 202 is turned on, the current flows from the first power supply terminal T1 to the resistor (TFT) 203. The channel is formed in the resistor 203 depending on a lower gate voltage Va2. After a predetermined period elapsed, the flowing current reaches saturation. After that, the output voltage Vout can be detected by use of the divided voltage depending on the resistance value of the resistor 203 (t14).

After a certain period further elapsed, if the voltage Vpulse is inputted to the first switching transistor 201, the second switching transistor 202 is turned off. Hence, the output voltage Vout becomes substantially 0 V (t13 in FIG. 10C).

Here, if the gate voltage Va2 is low, the channel width of the resistor 203 becomes narrow, too. Hence, timing when the current flowing in the resistor 203 reaches saturation becomes earlier in the case of the gate voltage Va2 than in the case of the gate voltage Va1. Accordingly, timing to detect the output voltage Vout becomes earlier, thus extending a period to stay at H level (t12 to t14).

In other words, if the Va value is small, the sensitivity of the photosensor 200 is improved, and also the sensitivity can be adjusted by a change in Va value.

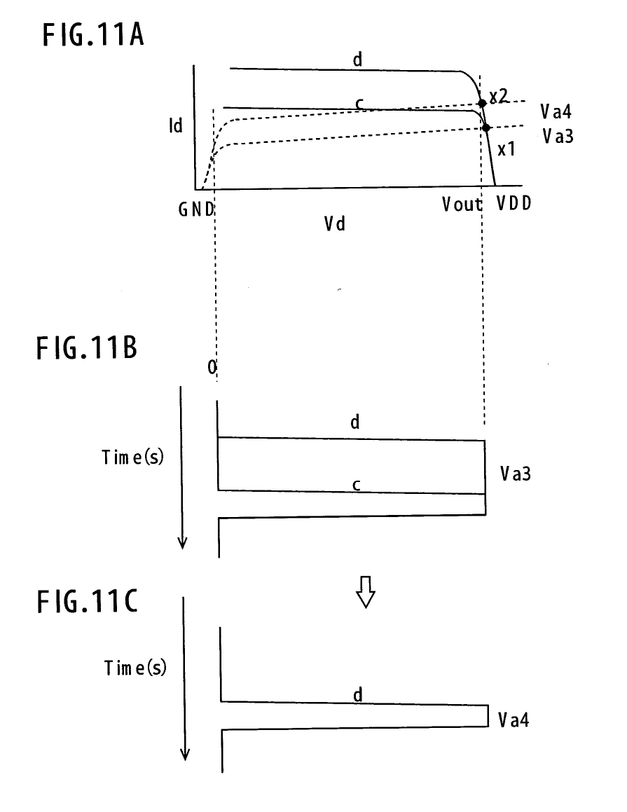

With reference to FIGS. 11A to 11C, descriptions will be further given. FIG. 11A shows an example of the gate voltage Va of the resistor 203 and the Vd-Id characteristics of the second switching transistor 202. Solid lines c and d indicate the Vd-Id characteristics of the second switching transistor 202. The solid line c indicates a state to have a large light quantity while the solid line d indicates a state to have a small light quantity. In addition, dotted lines Va3 and Va4 indicate the Vd-Id characteristics of the resistor (TFT) 203. The dotted line Va3 indicates a state to have a small gate voltage, and the dotted line Va4 indicates a state to have a large gate voltage. Moreover, FIG. 11B is a schematic diagram where the x-axis and y-axis of the output example of FIG. 10C are interchanged to correspond to FIG. 11A.

As shown in FIGS. 11A and 11B, in the case of the gate voltage Va3, there is an intersection x1 of the resistor 203, in the linear region of the second switching transistor 202 (the dotted line). Both the solid lines c and d can be detected as the output voltage Vout of H level. In the case of the solid line d, the output voltage Vout has a longer detection period than the solid line c.

On the other hand, as shown in FIGS. 11A and 11C, if the gate voltage Va is excessively high (Va4), there is only the solid line d at an intersection x2 in the linear region of the second switching transistor 202 (the dotted line). The solid line c shows that the output voltage Vout can not be detected since a saturation state at the resistor 203 brings a saturation state at the second switching transistor 202, too. In addition, the detection period of the solid line d is shortened.

Therefore, the voltage Vpulse and the gate voltage Va are selected suitably such that the Vd-Id curves of the resistor 203 intersect in the linear region of the second switching transistor 202.

In this manner, the photosensor 200 can obtain a binary output by turning on and off the second switching transistor 202. However, the output voltage Vout can be outputted in analog by calculating the integration area.

The above-mentioned photosensor 200 is connected to the gate line GL, the first power supply line PV and the second power supply line CV as shown in FIG. 7A. By use of these connections, the first power supply terminal T1 of the photosensor 200 can use the first power source of the display unit 21, and the second power supply terminal T2 of the photosensor 200 can use the potential of the second power supply line CV. As described above, the second power supply line CV is a power supply line with lower potential than that of the first power supply line PV.

Moreover, by being connected to the gate lines GL, the input signal Vpulse of the photosensor can use the gate signal of the display unit 21 in common. In other words, it is possible to set a scan signal (the gate signal) of a vertical driving circuit 23 as the input signal Vpulse and to reset the potential of the node n1.

Specifically, the gate signals are sequentially applied to the gate lines GL by use of a vertical driving circuit 23. The gate signals are binary signals of on (H level) and off (L level), which are to be the input signals Vpulse of the photosensor 200. When the gate signal at H level is applied to one of the gate lines GL by the vertical driving circuit 23, all the selection TFTs 4 connected to the relevant gate line GL are turned on. Meanwhile, the input signal at H level is applied to the first switching transistor 201 connected to the gate line GL, thus driving the photosensor 200.

The horizontal driving circuit 22 sequentially selects the drain lines DL to supply the data signals Vdata. Then, the organic EL element 7 emits light. External light is sensed by the photosensor 200.

The photosensor 200 detects the external light quantity, thus outputting its value as the output voltage Vout to the sense data line SL. The sense data line SL is connected to an external integrated circuit having, for example, a comparison circuit in order to perform processes such as comparing the external light quantity, for example, with surrounding display pixels 30, or with a presetted standard value. Thereby, the quantity of external light is detected.

In this manner, a signal line necessary to drive the photosensor 200 can be in common with the signal line of the display pixel 30. Hence, even if the photoreceptor circuit 200 is configured to be disposed in each of the pixel 30, it can be avoided to make wiring complex.

Furthermore, by adjusting the gate voltage Va of the TFT 203 to be a resistor, the sensitivity of detecting the output voltage Vout of the photosensor 200 can be changed.

Especially, since the photocurrent is a dark current of the phototransistor 205, variations in its values occur. However, since the sensitivity of detecting the output voltage Vout can be adjusted by use of the gate voltage Va of the resistor 203, the variations in the sensitivity of receiving light can be reduced between devices.

Moreover, with the above photosensor 200, the detection sensitivity can be adjusted by use of not only the Va value of the resistor 203 but the number of connections of the phototransistor 205, the intervals for the input signals (voltages) Vpulse or the capacitance of the capacitor 204. The number of connections of the phototransistor 205 contributes to the amount of the discharge of when the light of the organic EL element is sensed, and the intervals of the input signals Vpulse contribute to the period during which the output voltage Vout stays at H level as shown in FIG. 11. Further, the capacitance of the capacitor 204 is a potential to be applied to the gate electrode of the second switching transistor 202, and the potential is changed by discharging the electric charges from the capacitor 204 due to the relation of V=Q/C. That is, the smaller capacitance of the capacitor 204 can make the detection sensitivity increase.

Note that the circuit configuration shown in FIG. 9 is an example, and the connection position of the first switching transistor 201 and the phototransistor 205, the connection position of the second switching transistor 202 and the resistor 203 and the connection positions of the capacitor 204 can be changed. In other words, it is sufficient if the circuit is configured such that: the first switching transistor 201 is brought into conduction, thus charging the potential of the node n1 with the potential of the first power supply terminal T1 or second power supply terminal T2; the first switching transistor 201 is cut off, thus changing the potential of the node n1 by use of the discharge from the phototransistor 205; and the second switching transistor 202 is brought into conduction or is cut off by use of the potential of the node n1, thus detecting the output voltage from the node n2 of the second switching transistor 202 and the resistor 203.

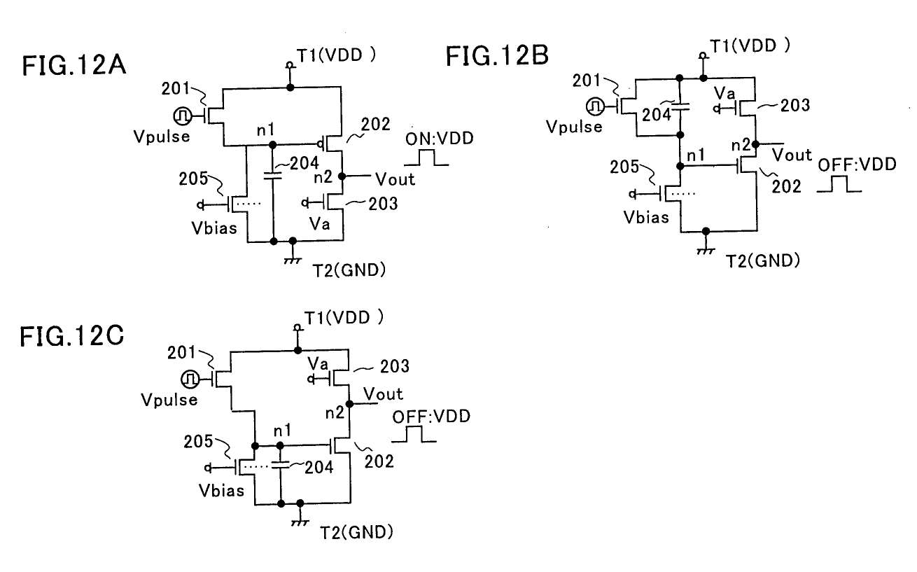

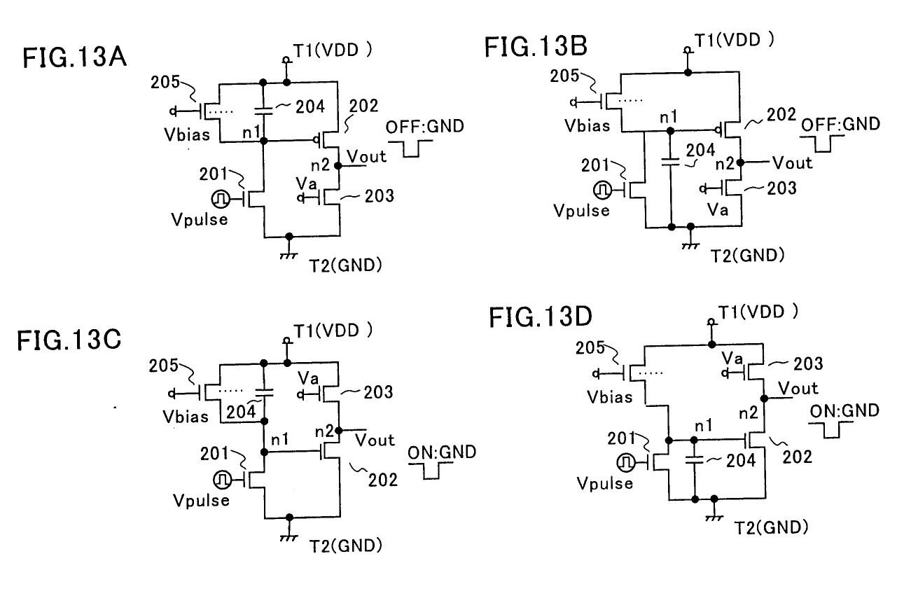

In FIGS. 12A to 13D, another configuration of a light quantity detection circuit in FIG. 9 is shown. First, FIG. 12 show a circuit which can detect the output voltage Vout at a potential close to that of the first power supply potential VDD.

FIG. 12A: the first switching transistor 201 is connected in series to the phototransistor 205, and is connected between the first power supply terminal T1 and the second power supply terminal T2. The second switching transistor 202 and the resistor 203 are connected in series, and they are also connected between the first power supply terminal T1 and the second power supply terminal T2. The second switching transistor 202 is a p-channel type TFT, and the resistor 203 is an n-channel type TFT. The capacitor 204 is connected in parallel to the phototransistor 205. One terminal of the capacitor 204 is connected to the control terminal of the second switching transistor 202 through the node n1, and the other terminal is connected to the second power supply terminal T2.

Pulses of a predetermined voltage Vpulse (H level) are inputted to the control terminal, that is, the gate electrode, of the first switching transistor 201 for a certain period of time. While the H level pulses are being inputted, the conduction of the first switching transistor 201 is maintained. With this, the capacitor 204 is charged with electric charges of the power supply potential VDD.

When the pulses fall to L level (0 V), the first switching transistor 201 is cut off. When the phototransistor 205 is irradiated with light, the electric charges are discharged from the phototransistor 205 depending on the light quantity, and the standard potential (VDD) of the node n1 decreases.

The second switching transistor 202 is brought into conduction after the potential of the node n1 falls to under the threshold voltage VTH. Therefore, the resistance value of the second switching transistor 202 becomes sufficiently smaller than that of the resistor 203, thus bringing the potential of the node n2 close to that of the first power supply terminal T1. Specifically, by bringing the second switching transistor 202 into conduction, the output voltage Vout can be outputted at a potential close to the power supply potential VDD by use of the photocurrent detected at the phototransistor 205 as a divided voltage of a potential difference between the power supply potential VDD and the ground potential GND.

FIG. 12B: the first switching transistor 201 is connected in series to the phototransistor 205, and is connected between the first power supply terminal T1 and the second power supply terminal T2. The second switching transistor 202 and the resistor 203 are connected in series, and they are also connected between the first power supply terminal T1 and the second power supply terminal T2. The second switching transistor 202 is an n-channel type TFT, and the resistor 203 is also an n-channel type TFT. The capacitor 204 is connected in parallel to the first switching transistor 201. One terminal of the capacitor 204 is connected to the control terminal of the second switching transistor 202 through the node n1, and the other terminal is connected to the first power supply terminal T1.

Pulses of a predetermined voltage Vpulse (H level) are inputted to the control terminal, that is, the gate electrode, of the first switching transistor 201 for a certain period of time. While the H level pulses are being inputted, the conduction of the first switching transistor 201 is maintained. With this, the capacitor 204 is charged with electric charges of the power supply potential VDD.

When the pulses fall to L level (0 V), the first switching transistor 201 is cut off. When the phototransistor 205 is irradiated with light, the electric charges are discharged from the phototransistor 205 depending on the light quantity, the standard potential (VDD) of the node n1 decreases.

The second switching transistor 202 of an n-channel type TFT is in conduction from a time to start the conduction of the first switching transistor 201 to a time to reach the threshold voltage VTH by decreasing the potential of the node n1. That is, while the second switching transistor 202 is in conduction, the resistance value of the second switching transistor 202 becomes sufficiently smaller than that of the resistor 203, thus bringing the potential of the node n2 close to that of the second power supply terminal T2. On the other hand, when the potential falls to under the threshold voltage VTH, the second switching transistor 202 is cut off. Therefore, the resistance value of the second switching transistor 202 becomes sufficiently larger than that of the resistor 203, thus bringing the potential of the node n2 close to that of the first power supply terminal T1. In other words, by cutting off the second switching transistor 202, the output voltage Vout can be outputted at a potential close to the power supply potential VDD by use of the photocurrent detected at the phototransistor 205 as a divided voltage of a potential difference between the power supply potential VDD and the ground potential GND.

FIG. 12C: the first switching transistor 201 is connected in series to the phototransistor 205, and is connected between the first power supply terminal T1 and the second power supply terminal T2. The second switching transistor 202 and the resistor 203 are connected in series, and they are also connected between the first power supply terminal T1 and the second power supply terminal T2. The second switching transistor 202 is an n-channel type TFT, and the resistor 203 is also an n-channel type TFT. The capacitor 204 is connected in parallel to the phototransistor 205. One terminal of the capacitor 204 is connected to the control terminal of the second switching transistor 202 through the node n1, and the other terminal is connected to the second power supply terminal T2.

Pulses of a predetermined voltage Vpulse (H level) are inputted to the control terminal, that is, the gate electrode, of the first switching transistor 201 for a certain period of time. While the H level pulses are being inputted, the conduction of the first switching transistor 201 is maintained. With this, the capacitor 204 is charged with electric charges of the power supply potential VDD.

When the pulses fall to L level (0 V), the first switching transistor 201 is cut off. When the phototransistor 205 is irradiated with light, the electric charges are discharged from the phototransistor 205 depending on the light quantity, the standard potential (VDD) of the node n1 decreases.

The second switching transistor 202 of an n-channel type TFT is in conduction from a time to start the conduction of the first switching transistor 201 to a time to reach the threshold voltage VTH by decreasing the potential of the node n1. That is, while the second switching transistor 202 is in conduction, the resistance value of the second switching transistor 202 becomes sufficiently smaller than that of the resistor 203, thus bringing the potential of the node n2 close to that of the second power supply terminal T2. On the other hand, when the potential falls to under the threshold voltage VTH, the second switching transistor 202 is cut off. Therefore, the resistance value of the second switching transistor 202 becomes sufficiently larger than that of the resistor 203, thus bringing the potential of the node n2 close to that of the first power supply terminal T1. In other words, by cutting off the second switching transistor, the output voltage Vout can be detected at a potential close to the power supply potential VDD.

FIGS. 13A to 13D show structures in which the connections of the first switching transistor 201 and the phototransistor 205 of FIGS. 9 and 12A to 12C are replaced. By use of this structure, the output voltage Vout can be detected at a potential close to that of the second power supply terminal T2.

FIG. 13A: the first switching transistor 201 is connected in series to the phototransistor 205, and is connected between the first power supply terminal T1 and the second power supply terminal T2. The second switching transistor 202 and the resistor 203 are connected in series, and they are also connected between the first power supply terminal T1 and the second power supply terminal T2. The second switching transistor 202 is a p-channel type TFT, and the resistor 203 is an n-channel type TFT. The capacitor 204 is connected in parallel to the phototransistor 205. One terminal of the capacitor 204 is connected to the control terminal of the second switching transistor 202 through the node n1, and the other terminal is connected to the first power supply terminal T1.

Pulses of a predetermined voltage Vpulse (H level) are inputted to the control terminal, that is, the gate electrode, of the first switching transistor 201 for a certain period of time. While the H level pulses are being inputted, the conduction of the first switching transistor 201 is maintained. With this, the capacitor 204 is charged with electric charges of the ground potential GND.

When the pulses fall to L level (0 V), the first switching transistor 201 is cut off. When the phototransistor 205 is irradiated with light, the electric charges are discharged from the phototransistor 205 depending on the light quantity, the standard potential (GND) of the node n1 increases.

The second switching transistor 202 of a p-channel type TFT is in conduction from a time to start the conduction of the first switching transistor 201 to a time to reach the threshold voltage VTH by decreasing the potential of the node n1. Consequently, when the second switching transistor 202 is in conduction, the potential of the node n2 draws close to that of the first power supply terminal T1. On the other hand, when the potential of the node n1 rises to over the threshold voltage, the second switching transistor 202 is cut off. Therefore, the potential of the node n2 draws close to that of the second power supply terminal T2. In other words, by cutting off the second switching transistor 202, the output voltage Vout can be detected at a potential close to the ground potential GND.

FIG. 13B: the first switching transistor 201 is connected in series to the phototransistor 205, and is connected between the first power supply terminal T1 and the second power supply terminal T2. The second switching transistor 202 and the resistor 203 are connected in series, and they are also connected between the first power supply terminal T1 and the second power supply terminal T2. The second switching transistor 202 is a p-channel type TFT, and the resistor 203 is an n-channel type TFT. The capacitor 204 is connected in parallel to the first switching transistor 201. One terminal of the capacitor 204 is connected to the control terminal of the second switching transistor 202 through the node n1, and the other terminal is connected to the second power supply terminal T2.

Pulses of a predetermined voltage Vpulse (H level) are inputted to the control terminal, that is, the gate electrode, of the first switching transistor 201 for a certain period of time. While the H level pulses are being inputted, the conduction of the first switching transistor 201 is maintained. With this, the capacitor 204 is charged with electric charges of the ground potential GND.

When the pulses fall to L level (0 V), the first switching transistor 201 is cut off. When the phototransistor 205 is irradiated with light, the electric charges are discharged from the phototransistor 205 depending on the light quantity, the standard potential (GND) of the node n1 increases.

The second switching transistor 202 of a p-channel type TFT is in conduction from a time to start the conduction of the first switching transistor 201 to a time to reach the threshold voltage VTH by increasing the potential of the node n1. Consequently, when the second switching transistor 202 is in conduction, the potential of the node n2 draws close to that of the first power supply terminal T1. On the other hand, when the potential of the node n1 rises to over the threshold voltage VTH, the second switching transistor 202 is cut off. Therefore, the potential of the node n2 draws close to that of the second power supply terminal T2. In other words, by cutting off the second switching transistor 202, the output voltage Vout can be detected at a potential close to the ground potential GND.

FIG. 13C: the first switching transistor 201 is connected in series to the phototransistor 205, and is connected between the first power supply terminal T1 and the second power supply terminal T2. The second switching transistor 202 and the resistor 203 are connected in series, and they are also connected between the first power supply terminal T1 and the second power supply terminal T2. The second switching transistor 202 is an n-channel type TFT, and the resistor 203 is also an n-channel type TFT. The capacitor 204 is connected in parallel to the phototransistor 205. One terminal of the capacitor 204 is connected to the control terminal of the second switching transistor 202 through the node n1, and the other terminal is connected to the first power supply terminal T1.

Pulses of a predetermined voltage Vpulse (H level) are inputted to the control terminal, that is, the gate electrode, of the first switching transistor 201 for a certain period of time. While the H level pulses are being inputted, the conduction of the first switching transistor 201 is maintained. With this, the capacitor 204 is charged with electric charges of the ground potential GND.

When the pulses fall to L level (0 V), the first switching transistor 201 is cut off. When the phototransistor 205 is irradiated with light, the electric charges are discharged from the phototransistor 205 depending on the light quantity, the standard potential (GND) of the node n1 increases.

The second switching transistor 202 of an n-channel type TFT is being cut off until the potential of the node n1 reaches the threshold voltage VTH, and when the potential rises to over the threshold voltage VTH, the second switching transistor 202 is brought into conduction. The potential of the node n2 draws close to that of the first power supply terminal T1 while the second switching transistor 202 is being cut off. When the second switching transistor 202 is brought into conduction, the potential of the node n2 draws closer to that of the second power supply terminal T2. In other words, the output voltage Vout can be outputted at a potential close to the ground potential GND by bringing the second switching transistor 202 into conduction.

FIG. 13D: the first switching transistor 201 is connected in series to the phototransistor 205, and is connected between the first power supply terminal T1 and the second power supply terminal T2. The second switching transistor 202 and the resistor 203 are connected in series, and they are also connected between the first power supply terminal T1 and the second power supply terminal T2. The second switching transistor 202 is an n-channel type TFT, and the resistor 203 is also an n-channel type TFT. The capacitor 204 is connected in parallel to the first switching transistor 201. One terminal of the capacitor 204 is connected to the control terminal of the second switching transistor 202 through the node n1, and the other terminal is connected to the second power supply terminal T2.

Pulses of a predetermined voltage Vpulse (H level) are inputted to the control terminal, that is, the gate electrode, of the first switching transistor 201 for a certain period of time. While the H level pulses are being inputted, the conduction of the first switching transistor 201 is maintained. With this, the capacitor 204 is charged with electric charges of the ground potential GND.

When the pulses fall to L level (0 V), the first switching transistor 201 is cut off. When the phototransistor 205 is irradiated with light, the electric charges are discharged from the phototransistor 205 depending on the light quantity, the standard potential (GND) of the node n1 increases.

The second switching transistor 202 of an n-channel type TFT is being cut off until the potential of the node n1 reaches the threshold voltage VTH, and when the potential rises to over the threshold voltage VTH, the second switching transistor 202 is brought into conduction. The potential of the node n2 draws close to that of the first power supply terminal T1 while the second switching transistor 202 is being cut off. When the second switching transistor 202 is brought into conduction, the potential of the node n2 draws closer to that of the second power supply terminal T2. In other words, the output voltage Vout can be outputted at a potential close to the ground potential GND by bringing the second switching transistor 202 into conduction.

In addition, although the illustration will be omitted, a resistive element can be connected as the resistor 203. The resistive element is formed by doping, for example, polysilicon, ITO or the like with an n-type impurity, and has a high resistance value of approximately 10³ Ω to 10⁸ Ω. In this case, by changing the resistance value of the resistive element 203, the condition becomes the same as a condition in which the constant value Va of the above-described circuit is changed. Thus, the sensitivity of the photosensor 200 can be adjusted.

As described above, the second switching transistor 202 in this embodiment uses a p-channel type TFT if one terminal of the second switching transistor 202 is connected to the first power supply terminal T1 with a high potential as shown in FIG. 9, 12A, 13A or 13B. To the contrary, the second switching transistor 202 uses an n-channel type TFT if one terminal of the second switching transistor 202 is connected to the second power supply terminal T2 with a low potential as shown in FIG. 12B, 12C, 13C or 13D.

Moreover, if the photoreceptor circuit 200 is connected to the light emitting circuit 180 as shown in FIG. 7A, the first power supply terminal T1 and the second power supply terminal T2 are connected to any one of the first power supply line PV and the second power supply line CV, respectively. It is sufficient for a potential in one of the light emitting pixel 30 if a relation where the first power source is larger than the second power source is viable. Hence, depending on the potential relation between the first power supply line PV and the second power supply line CV, the circuit is suitably selected from FIGS. 9, 12A to 12C and 13A to 13D.

Here, all the TFTs forming the photosensor 200 except for the phototransistor 205 may have a so-called top gate structure where a gate electrode is disposed above a semiconductor layer, similarly to the drive TFT 6 in FIG. 8, or may have a bottom gate structure where the gate electrode is disposed below the semiconductor layer. When the TFTs except the phototransistor 205 have a top gate structure, it is advantageous to provide a shielding layer for the TFTs. It is preferable, for example, to dispose the gate electrodes above and below the semiconductor layer, thus setting the gate electrode in the lower layer as the shielding layer. In this case, the potential of the gate electrode to be the shielding layer is appropriately selected according to the circuit configuration by setting the potential of the gate electrode to be floating, or to be common to or different from the gate electrode in the upper layer.

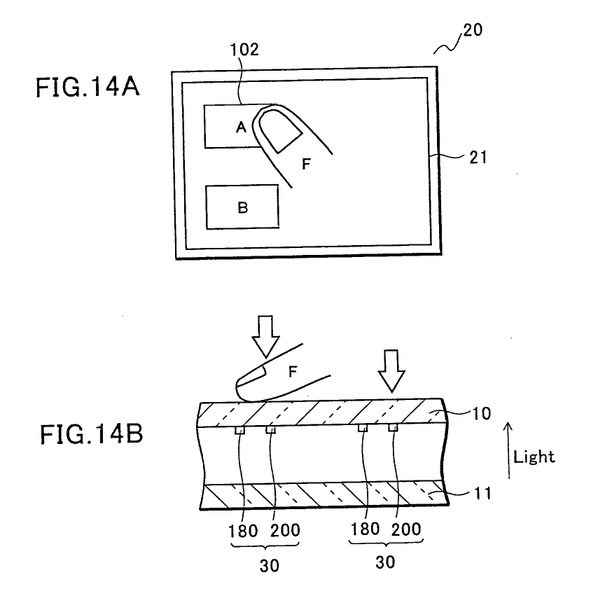

By use of FIGS. 14A and 14B, descriptions will be given of the operational principle of a touch panel 20 of the embodiment. The touch panel 20 displays images such as the buttons 102, for example, to let a user select a predetermined process by use of the plurality of display pixels 30. The user perceives the buttons 102 through the transparent substrate 10. If the user touches a button 102A to perform the predetermined process (see FIG. 14A), the external light which is incident to the photosensor 200 to be disposed in a manner of corresponding to the display pixel 30 for displaying the button 102A is blocked. On the other hand, external light is, without being blocked, incident to the photosensor 200 being disposed in a manner of corresponding to a button 102B which a finger F does not select.

Detection results of all the photosensors 200 for one frame are outputted to an external integrated circuit, which is not shown, through the sense data line SL. In the external integrated circuit, performed are, for example, processes such as comparison with the stored standard value, comparison with the photosensor 200 between the plurality of buttons 102 or the detection of the photosensor 200 in which the photocurrent is changed before and after the touch of the finger F. As the results of the comparisons, the pixel 30 (or the button 102) which receives less light than the standard value or other pixels 30 (or the buttons 102) is identified. Otherwise, the pixel 30 (or the button 102) in which the photocurrent is changed before and after the touch of the finger F is identified.

In this manner, by blocking light with the finger F, the position (the input coordinates) of the photosensor 200 whose quantity of received light has decreased is identified, thus detecting which one of the buttons 102 is selected by the finger F.

Moreover, even a subtle touch should be detected as an input in a touch panel. Hence, it is necessary for the photosensor 200 to be highly sensitive to received light. For example, the photosensor 200 can perform an analog output at between 0 and 5000 cd. However, when the photosensor 200 is employed in the touch panel 20, the photosensor 200 is set to be switched from on to off approximately at 10 cd. The following is an example for obtaining a high sensitivity to received light.

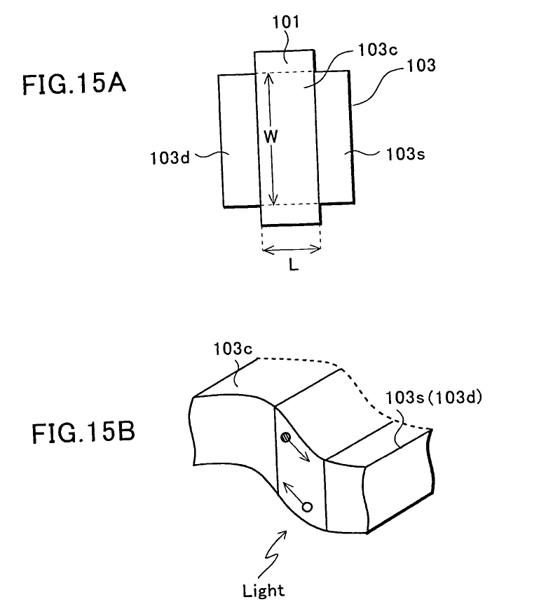

Firstly, with reference to FIGS. 15A and 15B, descriptions will be given of a case where a sensitivity of receiving light of the phototransistor 205 itself is increased.

The gate electrode 101 of the phototransistor 205 is disposed orthogonally to the semiconductor layer 103. At this time, the gate width W of the gate electrode 101 is set to be substantially longer than a gate length L. Specifically, the gate length L is desired to be approximately 5 μm to 15 μm and the gate width W is desired to be approximately 100 μm to 1000 μm. Note that the gate width W is a part where the gate electrode 101 and the semiconductor layer 103 are superimposed as shown in FIG. 15A.

FIG. 15B is a conceptual diagram showing, in three dimensions, a diagram of an energy band in the vicinity of the junction region between the channel 103c and the source 103s (or between the channel 103c and the drain 103d) of the semiconductor layer.

As described above, when the phototransistor 205 is off, if light is incident to the semiconductor layer 103 from outside, the electron-hole pairs are generated in the junction region between the channel 103c and the source 103s (or between the channel 103c and the drain 103d). Thus, the photocurrent can be obtained. That is, if the photocurrent is in a large amount, the sensitivity is high as the photosensor 200.

The place where the electron-hole pairs are generated by the incidence of light is the junction region between the channel 103c and the source 103s, which is shown in FIG. 15B with a hatching pattern. In other words, if the junction region is secured to be large, it is possible to obtain more photocurrent. Hence, a large area is secured for the junction region by widening the gate width W, which directly contributes to the junction region. Thus, the highly sensitive phototransistor 205 (the photosensor 200) is obtained. Since the gate width W can be widened with a change only in pattern, the highly sensitive photosensor 200 can be realized without increasing the number of separate processes.

Next, descriptions will be given of an example of increasing the sensitivity as the photosensor 200.

As described above, the photosensor 200 is configured to be connected to the first power supply line PV and the second power supply line CV and the gate line GL. In addition, the scan signal (the gate signal) of the vertical driving circuit 23 is set to be the input signal Vpulse. That is, this is the configuration in which the photosensor 200 switches from on to off as a photoreceptor circuit every frame time.

As shown in FIG. 10, the cycle of the input signal Vpulse contributes to a period during which the output voltage Vout is at H level. In other words, the longer a period of the H level is, the longer time to be able to detect the output voltage Vout is. Accordingly, the sensitivity is high as the photosensor.

Therefore, a low frequency is used for the scan signal (the gate signal) of the vertical driving circuit 23. For example, when employed is a frequency of the scan signal at 60 Hz for one frame, it is possible to extend the period of the H level by setting a frequency of the scan signal to be 15 Hz, 30 Hz or the like by use of a divider circuit.

Note that the embodiment can similarly be implemented even if the touch panel 20 has a top emission structure where light is emitted in the direction of the opposing substrate 11. In that case, since external light is incident from the direction of the opposing substrate 11, it is more suitable for the photosensor 200 to have a bottom gate structure where the gate electrode 101 is disposed below the semiconductor layer 103.

Furthermore, the photosensor 200 may be disposed in a manner of corresponding to each display pixel 30. Otherwise, one photosensor 200 may be disposed for the plurality of adjacent display pixels 30. Since the touch panel 20 can sufficiently detect the finger F as long as an area where the finger F touches is one square mm, the sensing can be performed while one photosensor 200 is disposed for four pixels, while one photosensor 200 is disposed for nine pixels, or the like.

As described above, the descriptions have been given of the example of the touch panel 20 in which the display unit 21 is formed of the display pixels 30 using the organic EL elements 7 in the embodiment. However, the embodiment is not limited to this, and can be implemented as long as a touch panel has pixels in which TFTs are made of low-temperature polysilicon, such as an LCD.

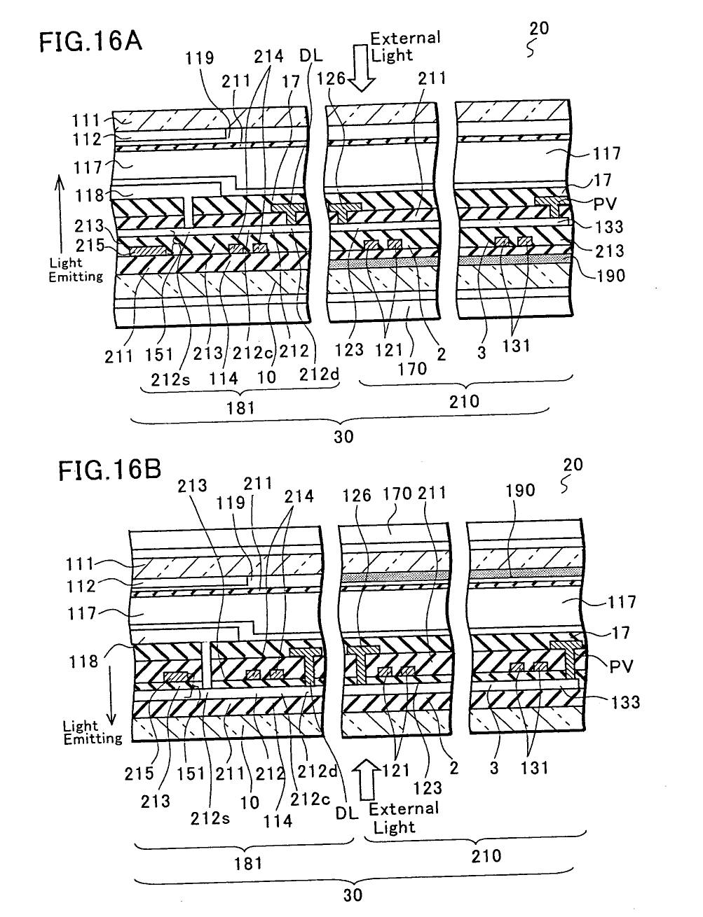

With reference to FIGS. 16A to 19, as third and fourth embodiments, descriptions will be given of a touch panel using a liquid crystal display (LCD) for a light emitting circuit of a display pixel 30.

The third embodiment is a case where an LCD is employed for the light emitting circuit of the first embodiment.

Schematic sectional views of a touch panel 20 are shown in FIGS. 16A and 16B. FIG. 16A is a case of a top emission structure in which light is emitted towards an opposing substrate 111 (upward). FIG. 16B is a case of a bottom emission structure in which light is emitted towards a substrate 10 (downward). Moreover, FIG. 16A is a case of a bottom gate structure, and FIG. 16B is a case of a top gate structure.

The substrate 10 is an insulating substrate such as glass, and the opposing substrate 111 is provided in opposition to the substrate 10. The substrate 10 and the opposing substrate 111 are fastened with a sealing agent (not shown). The display pixels 30 are disposed on the substrate 10. Each of the display pixels 30 has at least a light emitting circuit 181, and the light emitting circuit 181 has a selection TFT 114, a display electrode 118 and a hold capacitor 151. In addition, FIGS. 16A and 16B show one of the display pixel 30, however, actually a plurality of the display pixels 30 are arranged in a matrix form.

Moreover, a photoreceptor circuit (a photosensor) 210 is disposed adjacent to the light emitting circuit 181. Here, although the photosensor 210 is disposed in each of the display pixels 30, there may be some display pixels 30 in which the photosensor 210 may not be disposed and the light emitting circuit 181 alone may be disposed in the third embodiment.

If the selection TFT 114 has the bottom gate structure, a gate electrode 214, a gate insulation film 213 and a semiconductor layer (p-Si film) 212 are stacked on an insulation film 211 on the substrate 10. A channel 212c is provided in the semiconductor 212 above the gate electrode 214 (see FIG. 16A).

In addition, in the case of the top gate structure, the stacking order is: the semiconductor layer 212, the gate insulation film 213 and the gate electrode 214 (see FIG. 16B). A source 212s and a drain 212d are formed on both sides of the channel 212c by selectively diffusing impurities. The drain 212d is connected to a drain line DL through a contact hole provided in the insulation film 211 (and the gate insulation film 213). The surface of the drain line DL is covered with a planarizing insulation film 17. The source 212s is connected to the display electrode 118 through a contact hole provided in the planarizing insulation film 17 and the insulation film 211 (and the gate insulation film 213).

Additionally, the hold capacitor 151 is formed of a capacitance electrode line 215 which is in the same layer as the gate electrode 214, the gate insulation film 213 and the semiconductor layer 212.

On the display electrode 118, an orientation film (not shown) to orient liquid crystal is formed. The opposing substrate 111 is provided with the insulation film 211, a counter electrode 119, a color filter 112, the orientation film (not shown) and the like on the side of disposing the liquid crystal. The display electrode 118 is an independent pixel electrode for each display pixel 30, and the counter electrode 119 is an electrode common to each pixel 30 in a display unit 21. A liquid crystal layer 117 is filled in a space, which is hermetically sealed with the sealing agent, between the insulating substrate 10 and the opposing substrate 111.

A backlight 170 to be a light source unit is disposed at the back of the touch panel 20. The liquid crystal is driven by the selection TFT 114 to control (modulate) the light quantity such as the transmittance of the light of the backlight 170. Thus, light is emitted in the direction of an arrow.

In the case of the top emission structure, the color filter 112 is disposed on the opposing substrate 111 on the external light side (see FIG. 16A). In the case of the bottom emission structure, the color filter 112 is disposed on the opposing substrate 111 on the backlight 170 side (see FIG. 16B).

The photosensor 210 is disposed on the substrate 10 in the display pixel 30, and has a phototransistor 3. In FIGS. 16A and 16B, the phototransistor 3 and a selection TFT 2 are shown. Since the structure of the photosensor 210 is the same as that of FIG. 3 of the first embodiment, descriptions will be omitted. Note that the display pixel 30 may not include the photosensor 210, but may include the light emitting circuit 181 alone.

In the third embodiment, the photosensor 210 detects a difference in external light quantity which is incident to the display pixel 30, thus identifying input coordinates. Therefore, it is necessary to distinguish between the light of the backlight 170 and the external light to be detected. Hence, a shielding film 190 is provided between the photosensor 210 and the backlight 170 in order to block the light which is incident from the backlight 170.

The shielding film 190 is disposed in a position shown in FIG. 16A or 16B, respectively, depending on the case whether the emission direction of the touch panel is a top (FIG. 16A) or bottom (FIG. 16B) emission.

In other words, as shown in FIG. 16A, in the case of the top emission structure, the shielding film 190 is disposed on the substrate 10 between the backlight 170 and the photosensor 210. Thereon, TFTs to form the photosensor 210 are disposed.

On the other hand, as shown in FIG. 16B, in the case of the bottom emission structure, the shielding film 190 is disposed between the backlight 170 and the photosensor 210 on the liquid crystal layer 117 side of the counter electrode 119. TFTs to form the photosensor 210 are disposed below the shielding film 190.

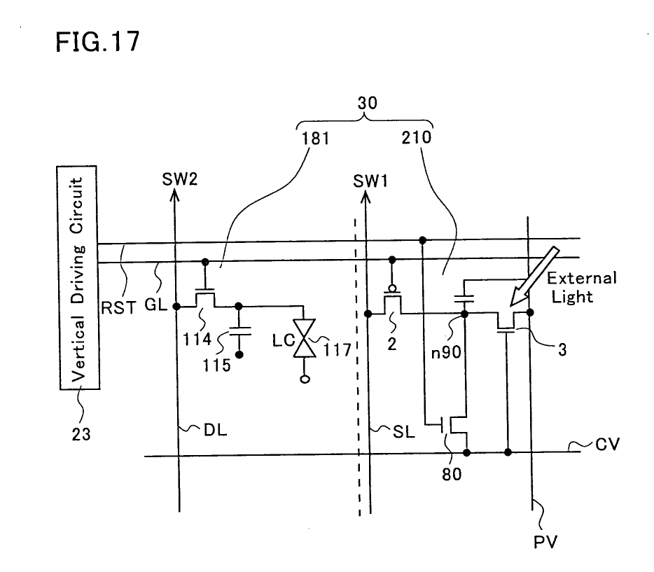

FIG. 17 shows a circuit diagram of one display pixel 30 being extracted. Here, shown is a case where one display pixel 30 includes the light emitting circuit 181 and the photosensor 210 therein. However, there may be some display pixels 30 which do not include the photosensor 210 therein, among the display pixels 30 within the same display unit 21.

The light emitting circuit 181 is formed of the liquid crystal layer 117, the selection TFT 114 and the hold capacitor 115, which are connected to each intersection of gate lines GL and the drain lines DL.

The selection TFT 114 has a gate connected to the gate line GL, a drain connected to the drain line DL (not shown), and a source connected to the hold capacitor 115 and one terminal (the display electrode 118) of the liquid crystal layer 117.

The other terminal (the counter electrode 119) of the liquid crystal layer 117 is electrically connected to a second power source. The second power source is a power source which inverts the potential at regular intervals. The other electrode of the hold capacitor 115 is connected to a constant power source such as a ground potential (GND).

When a pulse (a gate signal) under a standard voltage (L level) is applied from the gate line GL to the gate of the selection TFT 114, the selection TFT 114 of a p-channel type TFT is turned on. A data signal Vdata of the drain line DL is supplied to the display electrode 118 of the liquid crystal layer 117 and the hold capacitor 115 through the selection TFT 114. The data signal Vdata starts up along with the pulse of the gate, and maintains the value of when the gate voltage of the selection TFT 114 reaches an H level. The data signal Vdata is then applied to the liquid crystal layer 117. Thus, the liquid crystal is driven to control (modulate) the light quality such as the transmittance of the light of the backlight.

The hold capacitor 115 maintains the data signal Vdata until the next gate signal is supplied, thus driving the liquid crystal of the liquid crystal layer 117 until the next gate signal is applied.

Since the photosensor 210 to be a photoreceptor circuit is the same as the first embodiment, detailed descriptions will be omitted. However, while the phototransistor 3 in the first embodiment detects the reflected light of the light emitting circuit 180, the phototransistor 3 in the third embodiment detects external light.

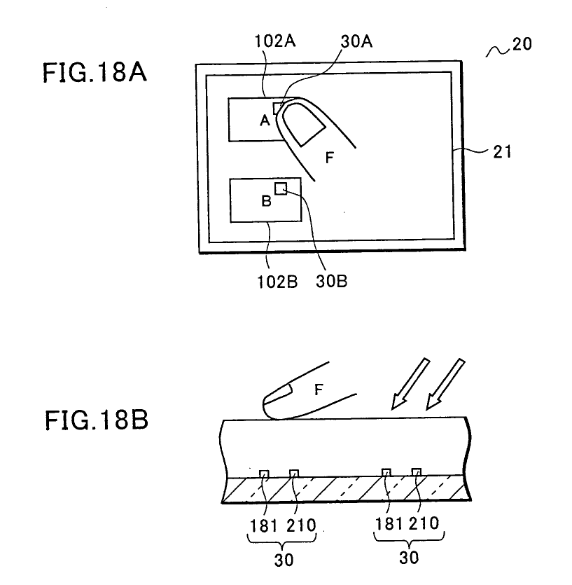

Here, by use of circuit diagrams of FIGS. 17 to 18B, descriptions will be given of operational principles of a touch panel 20 of the third embodiment.

The touch panel 20 displays images such as buttons 102, for example, to let a user select a predetermined process by use of the plurality of display pixels 30. If the user touches a button 102A to perform the predetermined process (see FIG. 18A), the external light in that area is blocked by a finger F. Thus, the external light is not incident to a photosensor 210A which is disposed in a manner of corresponding to the button 102A (a display pixel 30A). On the other hand, external light is incident to a display pixel 30B corresponding to a button 102B, which is not selected by the finger F. In this manner, the photosensor 210 detects the quantity of the external light to be incident thereto, thus determining whether or not the finger F is selecting the button 102.

With regard to the circuit operation at the time of sensing, firstly, a signal at H level is supplied to a reset line RST. Then, the potential of a node n90 becomes the same as that of a second power supply line CV. Thus, all the phototransistors 3, which correspond to the reset line RST, are resetted.

Upon supplying the H level signal to the reset line RST, the gate signal at L level is supplied to the gate line GL. Both of the selection TFT 114 in the display pixel 30 and the selection TFT 2 in the photosensor 210, which are connected to the gate line GL, are turned on. Next, the signal at H level is outputted from a shift resistor (not shown), thus resetting a sense data line SL.

When the button 102 is selected, the external light which is incident to the photosensor 210 is blocked. In other words, light is not incident to the phototransistor 3 of the display pixel 30 which constitutes the relevant button 102. Accordingly, a photocurrent is not generated. Since the photocurrent is a dark current of the phototransistor 3, when the photocurrent is not generated, the potential of the node n 90 remains almost the same as that of the reset state. Specifically, the potential of the node n90 is approximately equal to the potential of the second power supply line CV.

On the other hand, when the button 102 is not selected, external light is incident to the photosensor 210. That is, light is incident to the phototransistor 3 of the display pixel 30 which constitutes the relevant button 102, thus generating the photocurrent. Therefore, a voltage corresponding to the photocurrent enables the potential of the node n90 to increase more than that of the second power supply line CV. The potential of the node n90 becomes sensing data.

The potential of the node n90 is outputted as the sensing data from the phototransistor 3 to a COMP 160 through the selection TFT 2 and a switch SW1. The sensing data inputted to the COMP 160 and the potential of the second power supply line CV are compared, thus outputting a signal to a data line RL according to the result of the comparison. The signal (a detection value) is written in a frame memory 150 (see FIG. 2). Apart from this respect, all the respects are the same as the first embodiment.

The fourth embodiment is a case where an LCD is employed in the light emitting circuit of the second embodiment. A cross-sectional view of a touch panel of the fourth embodiment is similar to FIGS. 16A and 16B. The photosensors 210 in FIGS. 16A and 16B are set to be a photosensor 200.

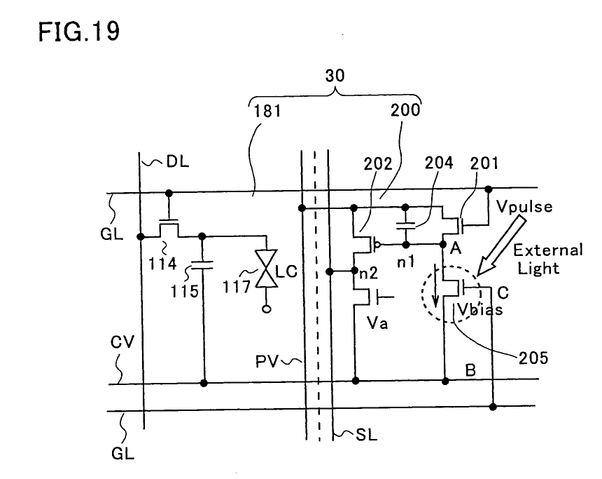

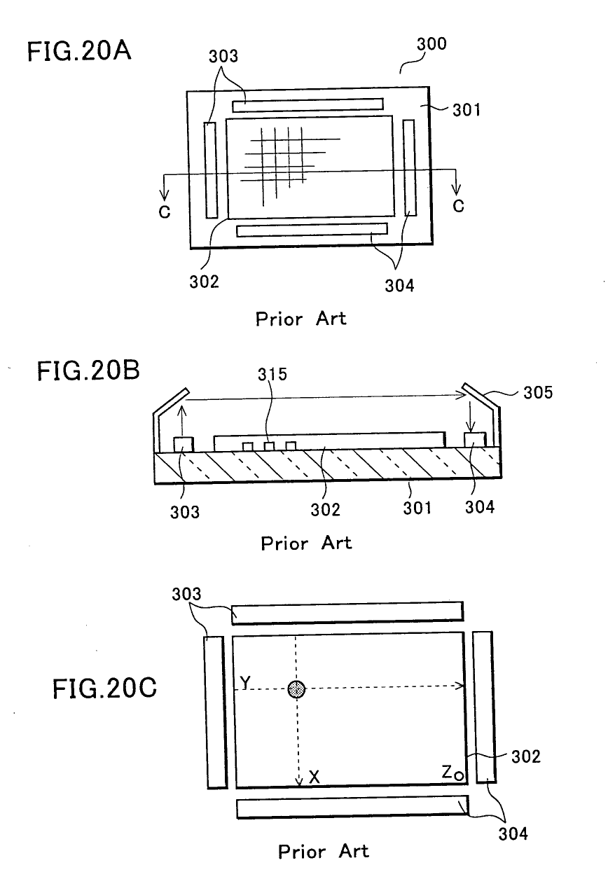

FIG. 19 is a circuit diagram in which one of display pixels 30 is extracted.

A light emitting circuit 181 is similar to that of the third embodiment. Incidentally, a hold capacitor 115 is connected to a source of a selection TFT 114, and the other electrode of the hold capacitor 115 is connected to a second power supply line CV.

A shielding film 190 for blocking the light of a backlight 170 is disposed between the photosensor 200 and the backlight 170, as shown in FIGS. 16A and 16B, in the fourth embodiment, too.

With reference to the circuit diagram of FIG. 19, descriptions will be given of an operational principle of a touch panel 20 of the fourth embodiment. Note that FIGS. 16A and 16B are referred to, regarding the touch panel 20. As described above, the reference numeral 210 in FIGS. 16A and 16B corresponds the photosensor 200.

When a gate signal is applied to a gate line GL, a selection TFT 114 is driven. Due to the drive of the liquid crystal, buttons 102 are displayed. In addition, the gate signal causes the photosensor 200 to drive. When the button 102 to be displayed by the display pixel 30 is not selected, a phototransistor in the photosensor 200 is irradiated with external light. Thus, a photocurrent is generated. Therefore, electric charge in accordance with the quantity of external light is discharged from the phototransistor. A standard potential (a VDD potential) of a node n1 falls as shown in FIG. 5A with solid lines.

A second switching transistor 202 is a p-channel type TFT. When the potential of the node n1 falls equal to or less than a threshold voltage VTH, the second switching transistor 202 is brought into conduction.

An output voltage Vout outputs a potential difference between a first power supply terminal T1 and a second power supply terminal T2 as a divided voltage between resistance values of the second switching transistor 202 and a resistor 203. In other words, the potential of a node n2 is brought close to that of the first power supply terminal T1 by bringing the second switching transistor 202 into conduction. Hence, the output voltage (H level), which is close to the power supply potential VDD, is outputted.

On the other hand, when the external light which is incident to the photosensor 200 is blocked by the selection of one of buttons 102, the falling of the potential of the node nil is prevented, and thus the second switching transistor 202 is not brought into conduction. When the second switching transistor 202 is not in conduction, the resistance value of the second switching transistor 202 becomes sufficiently larger than the resistance value of the resistor 203, and the potential of the node n2 is brought close to that of the second power supply terminal T2. Therefore, the output voltage Vout (L level), which is close to a ground potential GND, is outputted from a sense data line SL. The sense data line SL is connected to an external integrated circuit to identify the pixel in which the light quantity is changed.

Note that it is sufficient for the stacking order of phototransistors 3 and 205, a gate electrode and a semiconductor layer if the semiconductor layer of a TFT is on the side of receiving light in relation to the light to be detected. In other words, in the case of FIG. 16A, since external light is incident from an opposing substrate 111 side, it is advantageous to have a bottom gate structure where the semiconductor layer is in the upper layer (on an opposing substrate 111 side) and the gate electrode is in the lower layer (on a substrate 10 side). On the other hand, in the case of FIG. 16B, since external light is incident from the substrate 10 side, it is advantageous to have a top gate structure where the semiconductor layer is in the lower layer (on the substrate 10 side) and the gate electrode is in the upper layer (the opposing substrate 111 side).

The constructions of the photosensor circuits described above are also applicable to a reflection type liquid crystal display device.

According to the present embodiments of invention, first, a region of a photosensor, which is provided in the perimeter, becomes unnecessary by disposing a photosensor in a display unit. In other words, it is possible to contribute to the enlargement of a display area and the miniaturization of a device.

Second, since the light from a display pixel of the display unit is detected, it is unnecessary to separately provide a light emitting unit for distinguishing a touch point. Thus, it is possible to prevent an increase in the number of parts. Moreover, since the photosensor is not always in a driving state, but is driven at the same timing as the display pixel, it is possible to prevent the deterioration of a TFT.

Third, since the display pixel and the photosensor are close to each other, it is possible to sense uniformly. The sensitivity, such as reducing variations in sensing and eliminating a region where it is difficult for light to reach, is improved.

Fourth, if one photosensor is provided for the plurality of display pixels, a region for display is enlarged.

Fifth, since it is possible to be fabricated on the same substrate in the same process, it is possible to contribute to a significant reduction in the number of parts, and reductions in manufacturing cost and the number of manufacturing processes.

Sixth, the photosensor is provided in the display pixel in the display unit to detect the quantity of external light, thereby making it possible to identify input coordinates. Since the photosensor is formed of TFTs and is formed on the same substrate in the same process as the display pixel, it is possible to realize reductions in size, weight and thickness for a touch panel. Moreover, by reducing the number of parts, it is possible to provide a touch panel at low price.

Furthermore, since the photosensor is provided in the display pixel for displaying buttons and the like, it is possible to increase a precision in input recognition and to uniformly perform detection all over the display unit.

Seventh, since the photosensor is constituted of a photoreceptor circuit whose sensitivity of receiving light is adjustable, it is possible to make the sensitivity of receiving light (detection) of the display unit uniform. A photocurrent is a dark current of when a TFT is off, and is easy that variations in detection characteristics are generated. However, since the sensitivity of receiving light is adjustable according to the embodiments of the present invention, the sensitivity of receiving light between devices can be made uniform, thus making it possible to provide a touch panel in which the characteristics are stable.

Eighth, the power of the photoreceptor circuit and an input signal are supplied from a gate line, and first and second power supply lines. Therefore, the power source of the display pixel and the input signal can be made common. That is, even if it is configured that the photoreceptor circuit is disposed in each pixel, complex wiring can be avoided. Moreover, since the sensitivity of receiving light can be adjusted by use of the resistance value of a resistor which is constituted of the photoreceptor circuit, it is possible to make the sensitivity of receiving light almost uniform between the plurality of pixels.

Ninth, the phototransistor has an LDD structure, thus promoting the generation of the photocurrent. Especially, if the output side of the photocurrent is made the LDD structure, it is effective for the promotion of generating the photocurrent. Moreover, by adopting the LDD structure, the turn-off characteristics (the detection region) of Vg-Id characteristics are stabilized, and a stable device can be obtained.

What is claimed is:

1. A touch panel comprising:
a substrate;
a display area comprising a plurality of display pixels disposed on the substrate, each of the display pixels comprising a light emitting circuit;
a plurality of photosensor circuits disposed in the display area;
a horizontal driving circuit and a vertical driving circuit that drive the light emitting circuits and the photosensor circuits; and
a comparison circuit that is connected with the horizontal driving circuit and compares an output of one of the photosensor circuits with a predetermined standard.

2. The touch panel of claim 1, wherein the light emitting circuit comprises a pixel electrode, a luminescence layer, a drive transistor connected with the pixel electrode, and a selection transistor connected with the drive transistor.

3. The touch panel of claim 1, wherein the light emitting circuit comprises a pixel electrode, a liquid crystal layer, and a selection transistor connected with the pixel electrode.

4. The touch panel of claim 1, wherein the photosensor circuit comprises a phototransistor comprising a gate electrode, an insulation film and a semiconductor layer that comprises a channel, a source and a drain, the source and the drain being doped with impurities, and further comprises a selection transistor connected with the phototransistor.

5. The touch panel of claim 1, wherein the photosensor circuits are configured to be driven when corresponding light emitting circuits are driven.

6. The touch panel of claim 1, wherein the photosensor circuit is connected with the horizontal and vertical driving circuits.

7. The touch panel of claim 1, wherein one photosensor circuit is provided for every four neighboring display pixels.

8. The touch panel of claim 1, wherein one photosensor circuit is provided for every nine neighboring display pixels.

9. The touch panel of claim 1, wherein two or more display pixels share one photosensor circuit.

10. The touch panel of claim 1, wherein each of the photosensor circuits is configured to detect light generated by a corresponding light emitting circuit.

11. A touch panel comprising:
a substrate;
a plurality of data output lines disposed on the substrate;
a plurality of gate lines disposed on the substrate so as to intersect the data output lines;
a display area comprising a plurality of display pixels disposed on the substrate, each of the display pixels comprising a light emitting circuit and being disposed adjacent a corresponding intersection of the data output lines and the gate lines;
a plurality of photosensor circuits disposed in the display area, each of the photosensor circuits being disposed adjacent a corresponding intersection of the data output lines and the gate lines;
a horizontal driving circuit selecting sequentially the data output lines;
a vertical driving circuit supplying scan signals to the gate lines; and
a comparison circuit that is connected with the horizontal driving circuit and compares an output of one of the photosensor circuits with a predetermined standard.

12. The touch panel of claim 11, wherein the light emitting circuit comprises a pixel electrode, a luminescence layer, a drive transistor connected with the pixel electrode, and a selection transistor connected with the drive transistor.

13. The touch panel of claim 11, wherein the light emitting circuit comprises a pixel electrode, a liquid crystal layer, and a selection transistor connected with the pixel electrode.

14. The touch panel of claim 11, wherein the photosensor circuit comprises a phototransistor comprising a gate electrode, an insulation film and a semiconductor layer that comprises a channel, a source and a drain, the source and the drain being doped with impurities, and further comprises a selection transistor connected with the phototransistor.

15. The touch panel of claim 11, wherein the photosensor circuits are configured to be driven when corresponding light emitting circuits are driven.

16. The touch panel of claim 11, wherein the photosensor circuit is connected with the horizontal and vertical driving circuits.

17. The touch panel of claim 11, wherein one photosensor circuit is provided for every four neighboring display pixels.

18. The touch panel of claim 11, wherein one photosensor circuit is provided for every nine neighboring display pixels.

19. The touch panel of claim 11, wherein two or more display pixels share one photosensor circuit.

20. The touch panel of claim 11, wherein each of the photosensor circuits is configured to detect light generated by a corresponding light emitting circuit.

21. A touch panel comprising:
a substrate;
a plurality of data output lines disposed on the substrate;
a plurality of gate lines disposed on the substrate so as to intersect the data output lines;
a display area comprising a plurality of display pixels disposed on the substrate, each of the display pixels comprising a light emitting circuit and being disposed adjacent a corresponding intersection of the data output lines and the gate lines; and
a plurality of photosensor circuits disposed in the display area,
wherein the photosensor circuits are configured to be scanned so as to identify positions of the display area in which corresponding photosensor circuits do not detect external light incident on the display area.

22. The touch panel of claim 21, wherein each of the photosensor circuits comprises;
a phototransistor converting the external light incident thereon into an electric signal,
a first power supply terminal supplying a high potential and a second power supply terminal supplying a low potential,
a first switching transistor connected with the phototransistor in series between the first power supply terminal and the second power supply terminal,
a second switching transistor connected with a resistor in series between the first power supply terminal and the second power supply terminal, and
a capacitor, a first capacitor terminal of the capacitor being connected with a control terminal of the second switching transistor and a second capacitor terminal of the capacitor being connected with the first power supply terminal or the second power supply terminal.

23. The touch panel of claim 22, wherein the phototransistor comprises a semiconductor layer comprising a source, a drain and a channel disposed between the source and the drain, and the semiconductor layer is configured to receive light in a junction region between the channel and the source or the drain to generate a photocurrent.

24. The touch panel of claim 23, wherein a low concentration impurity region is provided between the source and the channel or between the drain and the channel.

25. The touch panel of claim 24, wherein the low concentration impurity region is provided on an output side of the photocurrent generated by the external light.

26. The touch panel of claim 21, wherein the light emitting circuit comprises a pixel electrode, a liquid crystal layer, and a selection transistor.

27. The touch panel of claim 26, further comprising a light source unit for the liquid crystal layer and a shielding film disposed between the light source unit and the photosensor circuits.

28. A touch panel comprising:
a substrate;
a plurality of data output lines disposed on the substrate;
a plurality of gate lines disposed on the substrate so as to intersect the data output lines;
a display area comprising a plurality of display pixels disposed on the substrate, each of the display pixels comprising a light emitting circuit comprising a drive transistor, an organic electroluminescent element and a selection transistor;
a plurality of photosensor circuits disposed in the display area, each of the photosensor circuits comprising thin film transistors each connected with a corresponding data output line or a corresponding gate line, and
a sensitivity adjustment circuit provided for each of the photosensor circuits and adjusting a light detecting sensitivity of a corresponding photosensor circuit,
wherein the photosensor circuits are configured to be scanned so as to identify positions of the display area in which corresponding photosensor circuits do not detect external light incident on the display area.

29. The touch panel of claim 28, wherein each of the photosensor circuits comprises;
a phototransistor converting the external light incident thereon into an electric signal;
a first power supply terminal supplying a high potential and a second power supply terminal supplying a low potential,
a first switching transistor connected with the phototransistor in series between the first power supply terminal and the second power supply terminal,
a second switching transistor connected with a resistor in series between the first power supply terminal and the second power supply terminal, the resistor being configured to operate as the sensitivity adjustment circuit, and
a capacitor, a first capacitor terminal of the capacitor being connected with a control terminal of the second switching transistor and a second capacitor terminal of the capacitor being connected with the first power supply terminal or the second power supply terminal.

30. The touch panel of claim 29, wherein the phototransistor comprises a semiconductor layer comprising a source, a drain and a channel disposed between the source and the drain, and the semiconductor layer is configured to receive light in a junction region between the channel and the source or the drain to generate a photocurrent.

31. The touch panel of claim 30, wherein a low concentration impurity region is provided between the source and the channel or between the drain and the channel.

32. The touch panel of claim 31, wherein the low concentration impurity region is provided on an output side of the photocurrent generated by the external light.

33. A touch panel comprising:
a substrate;
a display area comprising a plurality of display pixels disposed on the substrate;
a plurality of photosensor circuits disposed in the display area;
a horizontal driving circuit and a vertical driving circuit that drive the photosensor circuits; and
a comparison circuit that is connected with the horizontal driving circuit and compares an output of one of the photosensor circuits with a predetermined standard.

34. A touch panel comprising:
a substrate;
a plurality of data output lines disposed on the substrate;
a plurality of gate lines disposed on the substrate so as to intersect the data output lines;
a display area comprising a plurality of display pixels disposed on the substrate, each of the display pixels being disposed adjacent a corresponding intersection of the data output lines and the gate lines; and
a plurality of photosensor circuits disposed in the display area,
wherein the photosensor circuits are configured to be scanned so as to identify positions of the display area in which corresponding photosensor circuits do not detect external light incident on the display area.
